(19) United States
(12) Patent Application Publication
(10) Pub. No.: US 2024/0291967 A1
(43) Pub. Date: Aug. 29, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Lei ZHAO, Beijing (CN); Kai ZHANG, Los Angeles, CA (US); Li ZHANG, Los Angeles, CA (US)

(21) Appl. No.: 18/656,158

(22) Filed: May 6, 2024

Related U.S. Application Data
(63) Continuation of application No. PCT/CN2022/130075, filed on Nov. 4, 2022.

(30) Foreign Application Priority Data
Nov. 5, 2021 (WO) PCT/CN2021/129138

(51) Int. Cl. H04N 19/105; H04N 19/139; H04N 19/176; H04N 19/52

(52) U.S. Cl. CPC H04N 19/105; H04N 19/139; H04N 19/176; H04N 19/52

(57) ABSTRACT

Embodiments of the present disclosure provide a solution for video processing. A method for video processing is proposed. The method comprises: determining, during a conversion between a target video block of a video and a bitstream of the video, a plurality of candidates of the target video block; determining a candidate list from the plurality of candidates by using a plurality of thresholds; and performing the conversion based on the candidate list.

### CROSS-REFERENCE TO RELATED APPLICATIONS

This application is a continuation of International Application No. PCT/CN2022/130075, filed on Nov. 4, 2022, which claims the benefit of International Application No. PCT/CN2021/129138 filed on Nov. 5, 2021. The entire contents of these applications are hereby incorporated by reference in their entireties.

### FIELD

Embodiments of the present disclosure relates generally to video coding techniques, and more particularly, to candidate list construction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally very low, which is undesirable.

### SUMMARY

Embodiments of the present disclosure provide a solution for video processing.

In a first aspect, a method for video processing is proposed. The method comprises: determining, during a conversion between a target video block of a video and a bitstream of the video, a plurality of candidates of the target video block; determining a candidate list from the plurality of candidates by using a plurality of thresholds; and performing the conversion based on the candidate list.

The method in accordance with the first aspect of the present disclosure determines a candidate list by using a plurality of thresholds. Compared with the conventional solution where only one threshold is involved in the candidate list construction, the candidate list determined based on a plurality of thresholds can be more appropriate, and thus the coding effectiveness and coding efficiency can be improved.

In a second aspect, another method for video processing is proposed. The method comprises: determining, during a conversion between a target video block of a video and a bitstream of the video, a plurality of motion vector prediction (MVP) candidates of the target video block; determining an MVP candidate list by performing a plurality of reordering processes of the plurality of MVP candidates; and performing the conversion based on the MVP candidate list.

The method in accordance with the second aspect of the present disclosure performs plurality of reordering processes to determine an MVP candidate list. For example, the plurality of reordering processes may be a multi-pass reordering. Compared with the conventional solution where the MVP candidate list are constructed by using only one reordering, the MVP candidate list determined by the plurality of reordering processes can be more appropriate, and thus the coding effectiveness and coding efficiency can be improved.

In a third aspect, another method for video processing is proposed. The method comprises: determining, during a conversion between a target video block of a video and a bitstream of the video, at least one group of motion vector prediction (MVP) candidates of the target video block; determining an MVP candidate list based on the at least one group of MVP candidate and at least one virtual MVP candidate; and performing the conversion based on the MVP candidate list.

The method in accordance with the third aspect of the present disclosure involves the virtual candidates in constructing the MVP candidate list. Compared with the conventional solution where the virtual candidate is not involved in the MVP candidate list construction, the MVP candidate list determined with the virtual candidates taken into consideration can be more appropriate, and thus the coding effectiveness and coding efficiency can be improved.

In a fourth aspect, another method for video processing is proposed. The method comprises: determining, during a conversion between a target video block of a video and a bitstream of the video, a plurality of motion vector prediction (MVP) candidates of the target video block; determining a group of MVP candidates from the plurality of MVP candidates based on a threshold number; and performing the conversion based on the group of MVP candidates.

The method in accordance with the fourth aspect of the present disclosure setting a threshold number for the group of MVP candidates. Compared with the conventional solution where no threshold number is determined for the group of MVP candidates, the group of MVP candidates with the threshold number can be more appropriate, and thus the coding effectiveness and coding efficiency can be improved.

In a fifth aspect, an apparatus for processing video data is proposed. The apparatus for processing video data comprises a processor and a non-transitory memory with instructions thereon. The instructions upon execution by the processor, cause the processor to perform a method in accordance with the first, second, third or fourth aspect of the present disclosure.

In a sixth aspect, a non-transitory computer-readable storage medium is proposed. The non-transitory computer-readable storage medium stores instructions that cause a processor to perform a method in accordance with the first, second, third or fourth aspect of the present disclosure.

In a seventh aspect, a non-transitory computer-readable recording medium is proposed. The non-transitory computer-readable recording medium stores a bitstream of a video which is generated by a method performed by a video processing apparatus. The method comprises: determining a plurality of candidates of a target video block of the video; determining a candidate list from the plurality of candidates by using a plurality of thresholds; and generating the bitstream based on the candidate list.

In an eighth aspect, a method for storing a bitstream of a video is proposed. The method comprises: determining a plurality of candidates of a target video block of the video; determining a candidate list from the plurality of candidates by using a plurality of thresholds; generating the bitstream based on the candidate list; and storing the bitstream in a non-transitory computer-readable recording medium.

In a ninth aspect, another non-transitory computer-readable recording medium is proposed. The non-transitory computer-readable recording medium stores a bitstream of a video which is generated by a method performed by a video processing apparatus. The method comprises: determining a plurality of motion vector prediction (MVP) candidates of the target video block of the video; determining an MVP candidate list by performing a plurality of reordering processes of the plurality of MVP candidates; and generating the bitstream based on the MVP candidate list.

In a tenth aspect, a method for storing a bitstream of a video is proposed. The method comprises: determining a plurality of motion vector prediction (MVP) candidates of the target video block of the video; determining an MVP candidate list by performing a plurality of reordering processes of the plurality of MVP candidates; generating the bitstream based on the MVP candidate list; and storing the bitstream in a non-transitory computer-readable recording medium.

In an eleventh aspect, another non-transitory computer-readable recording medium is proposed. The non-transitory computer-readable recording medium stores a bitstream of a video which is generated by a method performed by a video processing apparatus. The method comprises: determining at least one group of motion vector prediction (MVP) candidates of the target video block of the video; determining an MVP candidate list based on the at least one group of MVP candidate and at least one virtual MVP candidate; and generating the bitstream based on the MVP candidate list.

In a twelfth aspect, a method for storing a bitstream of a video is proposed. The method comprises: determining at least one group of motion vector prediction (MVP) candidates of the target video block of the video; determining an MVP candidate list based on the at least one group of MVP candidate and at least one virtual MVP candidate; generating the bitstream based on the MVP candidate list; and storing the bitstream in a non-transitory computer-readable recording medium.

In a thirteenth aspect, another non-transitory computer-readable recording medium is proposed. The non-transitory computer-readable recording medium stores a bitstream of a video which is generated by a method performed by a video processing apparatus. The method comprises: determining a plurality of motion vector prediction (MVP) candidates of the target video block of the video; determining a group of MVP candidates from the plurality of MVP candidates based on a threshold number; and generating the bitstream based on group of MVP candidates.

In a fourteenth aspect, a method for storing a bitstream of a video is proposed. The method comprises: determining a plurality of motion vector prediction (MVP) candidates of the target video block of the video; determining a group of MVP candidates from the plurality of MVP candidates based on a threshold number; generating the bitstream based on group of MVP candidates; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an example diagram showing positions of spatial and temporal neighboring blocks used in AMVP/merge candidate list construction;

FIG. 5 illustrates an example diagram showing positions of non-adjacent candidate in ECM;

FIG. 6 illustrates an example diagram showing template matching performs on a search area around initial MV;

FIG. 7 illustrates an example diagram showing a template and the corresponding reference template;

FIG. 8 illustrates an example diagram showing template and reference template for block with sub-block motion using the motion information of the subblocks of current block;

FIG. 9 illustrates an example diagram showing an example of the positions for non-adjacent TMVP candidates;

FIG. 10 illustrates an example diagram showing an example of the template;

FIG. 11 illustrates a flowchart of a method for video processing in accordance with some embodiments of the present disclosure;

FIG. 12 illustrates another flowchart of a method for video processing in accordance with some embodiments of the present disclosure;

FIG. 13 illustrates another flowchart of a method for video processing in accordance with some embodiments of the present disclosure;

FIG. 14 illustrates another flowchart of a method for video processing in accordance with some embodiments of the present disclosure; and

FIG. 15 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

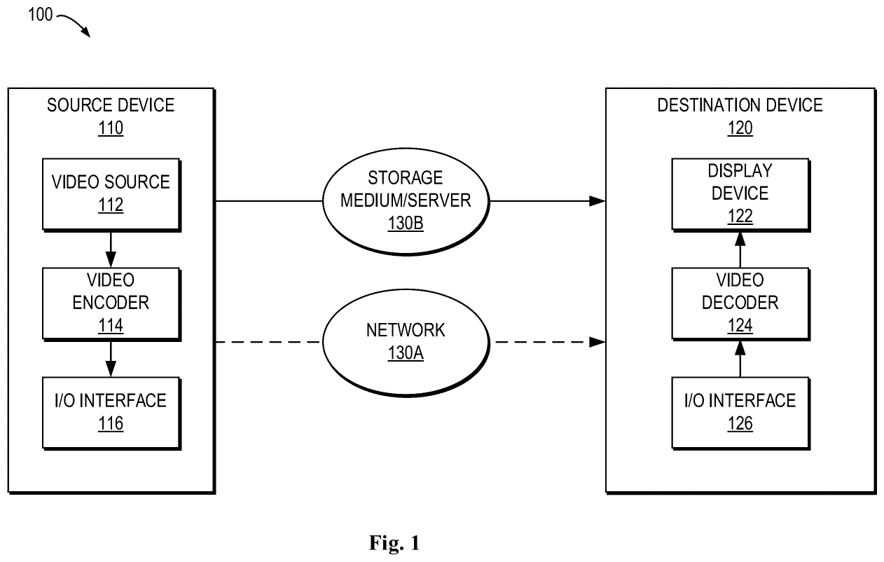

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

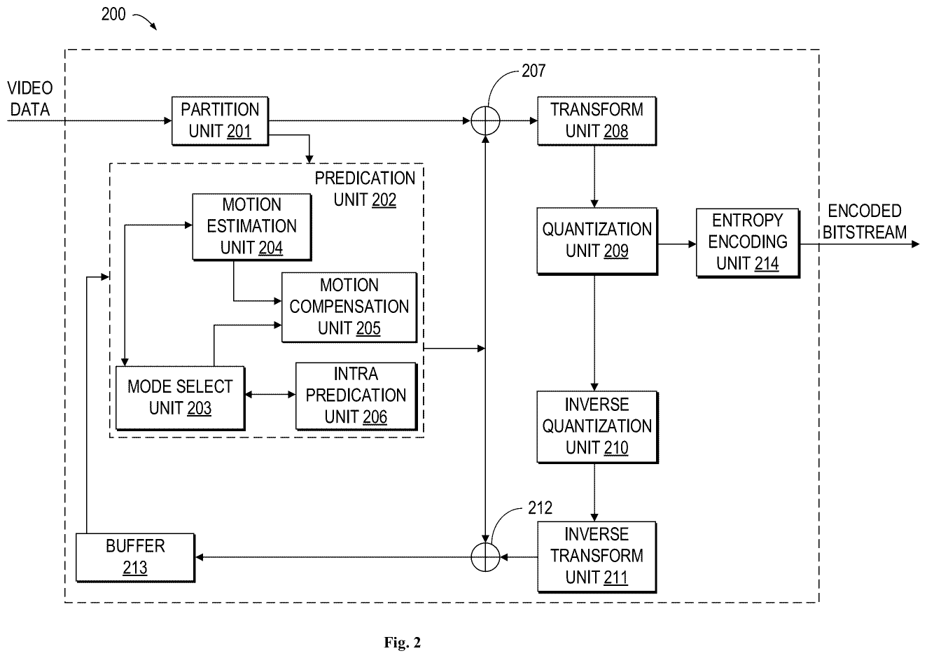

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

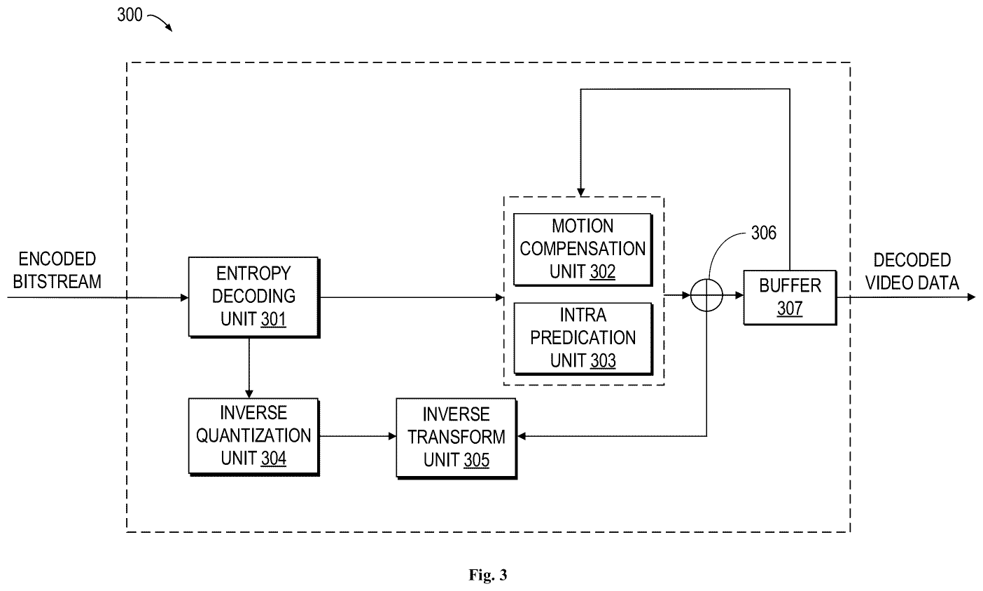

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Summary

This disclosure is related to video coding technologies. Specifically, it is about motion vector prediction (MVP) construction method in video coding. The ideas may be applied individually or in various combination, to any video coding standard or non-standard video codec.

### 2. Background

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized.

### 2.1. MVP in Video Coding

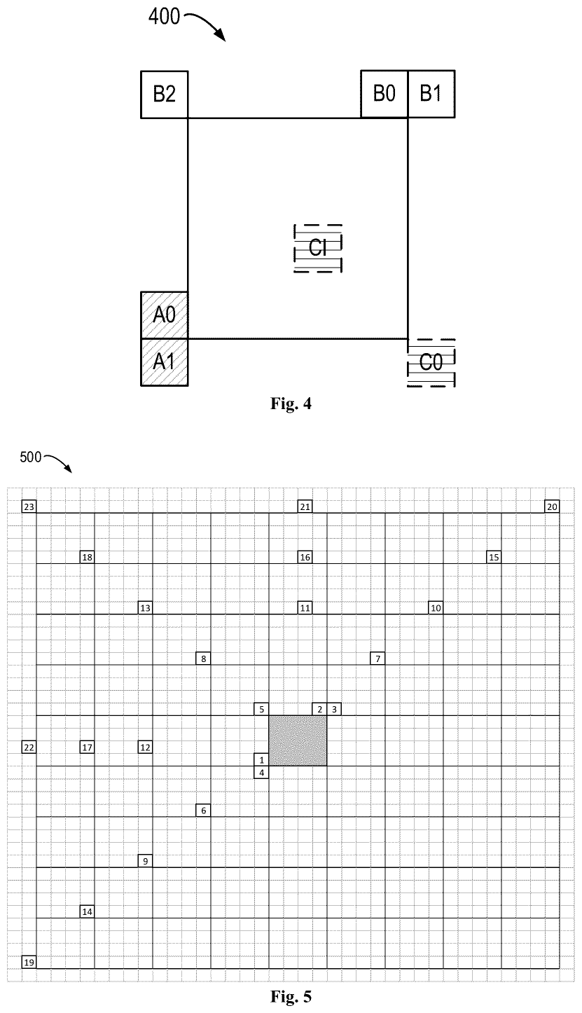

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC, competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, an MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.
AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. FIG. 4 illustrates an example diagram 400 showing positions of spatial and temporal neighboring blocks used in AMVP/merge candidate list construction. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different co-located positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list.
Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.
In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.
During the standardization of VVC, Non-adjacent MVP was proposed to facilitate better motion information derivation by exploiting the non-adjacent area. FIG. 5 illustrates an example diagram 500 showing positions of non-adjacent candidate in ECM. In ECM software, Non-adjacent MVP are inserted between TMVP and HMVP, where the distances between non-adjacent spatial candidates and current coding block are based on the width and height of current coding block as depicted in FIG. 5.

### 2.2. Interpolation Filters in VVC

In VVC, interpolations filters are used in both intra and inter coding process. Intra coding takes advantage of interpolation filters to generate fractional positions in angular prediction modes. In HEVC, a two-tap linear interpolation filter has been used to generate the intra prediction block in the directional prediction modes (i.e., excluding Planar and DC predictors). While in VVC, four-tap intra interpolation filters are utilized to improve the angular intra prediction accuracy. In particular, two sets of 4-tap interpolation filters are utilized in VVC intra coding, which are DCT-based interpolation filter (DCTIF) and smoothing interpolation filter (SIF). The DCTIF is constructed in the same way as the one used for chroma component motion compensation in both HEVC and VVC. The SIF is obtained by convolving the 2-tap linear interpolation filter with [1 2 1]/4 filter.
In VVC, the highest precision of explicitly signaled motion vectors is quarter-luma-sample. In some inter prediction modes such as the affine mode, motion vectors are derived at 1/16th-luma-sample precision and motion compensated prediction is performed at 1/16th-sample-precision. VVC allows different MVD precision ranging from 1/16-luma-sample to 4-luma-sample. For half-luma-sample precision, 6-tap interpolation filter is used. While for other fractional precisions, default 8-tap filter is used. Besides, the bilinear interpolation filter is used to generate the fractional samples for the searching process of decoder side motion vector refinement (DMVR) in VVC.

### 2.3. Template Matching Merge/AMVP Mode in ECM

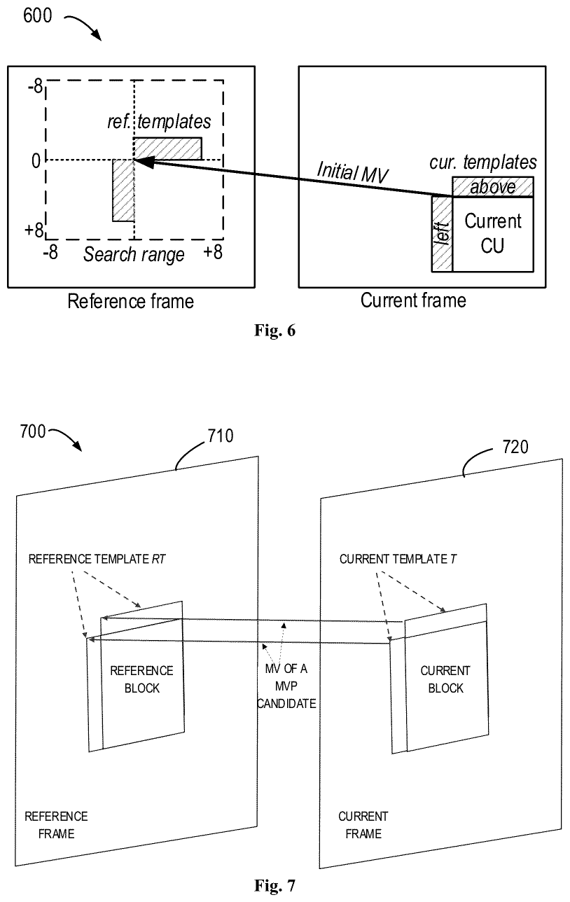

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. FIG. 6 illustrates an example diagram 600 showing template matching performs on a search area around initial MV. As illustrated in FIG. 6, a better MV is to be searched around the initial motion of the current CU within a [−8, +8]-pel search range.
In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]−pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.
In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4. Adaptive Reorder of Merge Candidates (ARMC)

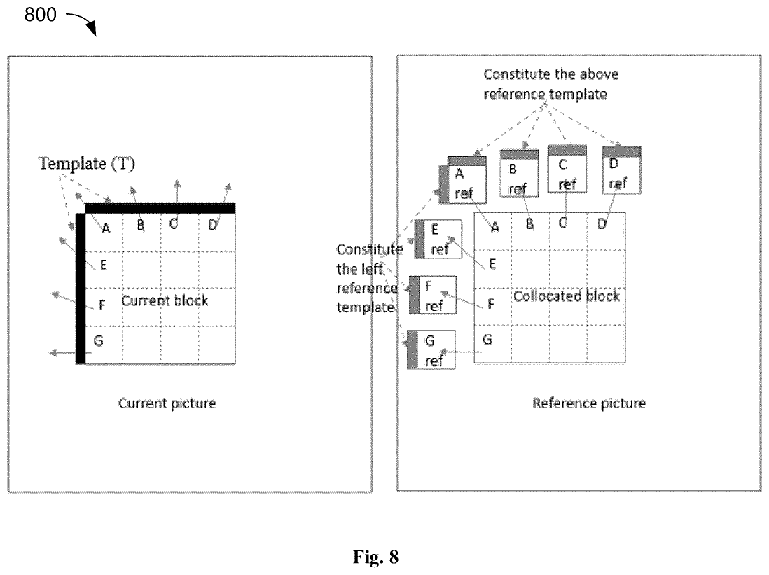

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.
The reordering method is applied to regular merge mode, template matching (TM) merge mode, and affine merge mode (excluding the SbTMVP candidate). For the TM merge mode, merge candidates are reordered before the refinement process.
After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered.
FIG. 7 illustrates an example diagram 700 showing a template 720 and the corresponding reference template 710. The template matching cost is measured by the sum of absolute differences (SAD) between samples of a template of the current block and their corresponding reference template. The template 720 comprises a set of reconstructed samples neighboring to the current block, while reference template 710 is located by the same motion information of the current block, as illustrated FIG. 7. When a merge candidate utilizes bi-directional prediction, the reference samples of the template of the merge candidate are also generated by bi-prediction.
For subblock-based merge candidates with subblock size equal to Wsub*Hsub, the above template comprises several sub-templates with the size of Wsub×1, and the left template comprises several sub-templates with the size of 1×Hsub. FIG. 8 illustrates an example diagram 800 showing template and reference template for block with sub-block motion using the motion information of the subblocks of current block. As shown in FIG. 8. the motion information of the subblocks in the first row and the first column of current block is used to derive the reference samples of each sub-template.

### 2.5. Enhanced MVP Candidate Derivation (EMCD)

EMCD based on template matching cost reordering has been proposed. Instead of constructing the MVP list based on a predefined traversing order, an optimized MVP selecting approach by taking advantage of the matching cost in the reconstructed template region, such that more appropriate candidates are included in the list is investigated.
It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.

### Non-Adjacent TMVP

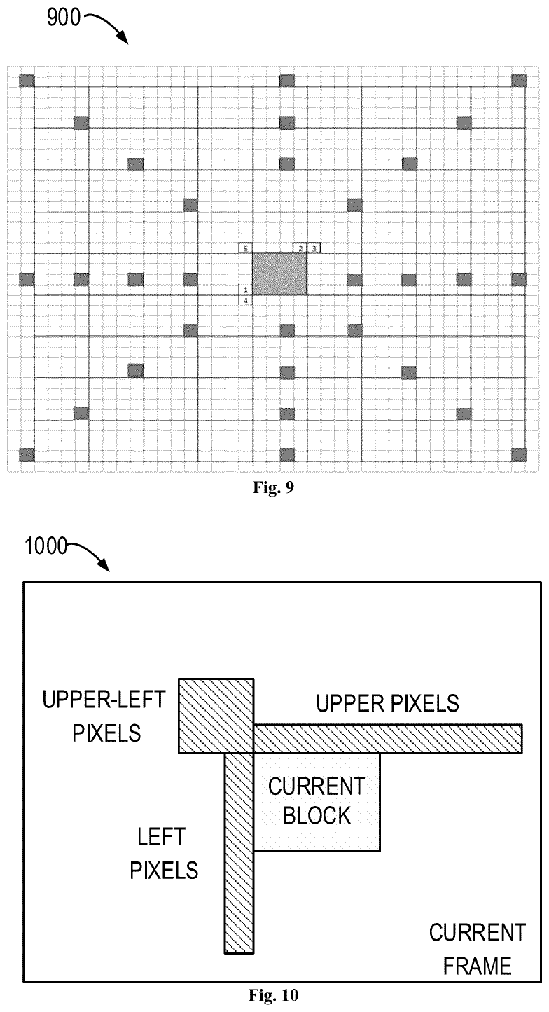

1. It is proposed to make use of the TMVP in a non-adjacent area to further improve the effectiveness of the MVP list.
   a) In one example, a non-adjacent area may be any block (such as 4×4 block) in a reference picture and neither inside nor adjacent to the collocated block in the reference picture of the current block.
   b) FIG. 9 illustrates an example diagram 900 showing an example of the positions for non-adjacent TMVP candidates. In one example, the positions of the non-adjacent TMVP candidates are illustrated in FIG. 9, where black blocks represent the potential non-adjacent TMVP positions. It should be noted that this figure only provides an example for non-adjacent TMVP, and the positions are not limited to the indicated blocks. In other cases, non-adjacent TMVP may locate in any other positions in one or more reconstructed frames.
2. The maximum allowed non-adjacent TMVP number in the MVP list may be signaled in the bitstream.
   a) In one example, the maximum allowed number can be signaled in SPS or PPS.
3. The non-adjacent TMVP candidates may locate in the nearest reconstructed frame, but it may also locate in other reconstructed frames.
   a) Alternatively, non-adjacent TMVP candidates may locate in the collocated picture.
   b) Alternatively, it is signaled in which picture non-adjacent TMVP candidates may locate.
4. Non-adjacent TMVP candidates may locate in multiple reference pictures.
5. The distances between a non-adjacent area associated with a TMVP candidate and current coding block may be related to the property of the current block.
   a) In one example, the distances depend on the width and height of current coding block.
   b) In other cases, the distances may be signaled in the bitstream as a constant.

### Definition of the Template

6. Template represents the reconstructed region that can be used to estimate the priority of a MVP candidate, which may locate in different positions with variable shape. FIG. 10 illustrates an example diagram 1000 showing an example of the template.
   a) In one example, a template may comprise of the reconstructed regions in three positions, which are upper pixels, left pixels and upper-left pixels, as presented in FIG. 10.
   b) It should be noted that the template may not necessarily be in rectangular shape, it can be in arbitrary shape, e.g., triangle or polygon.
   c) In one example, the template regions may be utilized either in separate or combined manner.
   d) A template may only comprise samples from one component such as luma, or from multiple components such as luma and chroma.
7. The template may not necessarily locate in the current frame, it may locate in any other reconstructed frame.
8. In one example, a reference template region with the same shape as the template of the current block may be located with a MV, as shown in FIG. 7.
9. In one example, the template may not necessarily locate in adjacent area, it may locate in non-adjacent areas that are far away from the current block.
10. In one example, a template may not necessarily contain all the pixels in a certain region, it may contain part of the pixels in a region.

### Template Matching Based MVP Candidate Ordering

11. In embodiments of the present disclosure, template matching cost associated with a certain MVP candidate serves as a measurement to evaluate the consistency of this candidate and true motion information. Based on this measurement, a more efficient order is generated by sorting the priority of each MVP candidate.
   a) In one example, the template matching cost C is evaluated with mean of square error (MSE), as calculated below:

$$C = \frac{{\sum }_{( i , j ) ∈ T} {( T ( i , j ) - R T ( i , j ) )}^{2}}{N} ,$$

where T represents the template region, RT represents the corresponding reference template region specified by the MV within MVP candidate (FIG. 7), N is the pixel number within the template.
b) In one example, the template matching cost can be evaluated with sum of square error (SSE), sum of absolute difference (SAD), sum of absolute transformed difference (SATD) or any other criterion that can measure the difference between two regions.
12. All the MVP candidates are sorted in an ascending order regarding the corresponding template matching cost, and the MVP list is constructed by traversing the candidates in the sorted order until the MVP amount reaches the maximum allowed number. In this way, a candidate with a lower matching cost has a higher priority to be included in the ultimate MVP list.
   a) In one example, the sorting process may be conducted towards all the MVP candidates.
   b) Alternatively, this process may also be applied to part of candidates, e.g., non-adjacent MVP candidates, HMVP candidates or any other group of candidates.
   c) Alternatively, furthermore, which categories of MVP candidates (e.g., non-adjacent MVP candidates are belonging to one category, HMVP candidates are belonging to another category) and/or what kinds of group of candidates should be reordered may be dependent on the decoded information, e.g., block dimension/coding methods (e.g., CIIP/MMVD) and/or how many available MVP candidates before being reordered for a given kind/group.
      1. In one example, the sorting process may be conducted for a joint group which contains only one category of MVP candidates.
      2. In one example, the sorting process may be conducted for a joint group which contains more than one category of MVP candidates.
         a) In one example, for a first coding method (e.g., regular/CIIP/MMVD/GPM/TPM/subblock merge mode), the sorting process can be conducted for a joint group of non-adjacent MVP, non-adjacent TMVP and HMVP candidates. For a second coding method (e.g., the template matching merge mode), the sorting process can be conducted for a joint group of adjacent MVP, non-adjacent TMVP, non-adjacent MVP and HMVP candidates.
         b) Alternatively, for a first coding method (e.g., regular/CIIP/MMVD/GPM/TPM/subblock merge mode), the sorting process can be conducted for a joint group of non-adjacent MVP and HMVP candidates. For a second coding method (e.g., the template matching merge mode), the sorting process can be conducted for a joint group of adjacent MVP, non-adjacent MVP and HMVP candidates.
      3. In one example, the sorting process may be conducted for a joint group which contains partial of available MVP candidates within the categories.
         a) In one example, for regular/CIIP/MMVD/TM/GPM/TPM/subblock merge mode, or for regular/affine AMVP mode, the sorting process can be conducted for a joint group of all or partial candidates from one or multiple categories.
      4. In above examples, the category may be
         i. adjacent neighboring MVPs;
         ii. adjacent neighboring MVPs at specific location(s);
         iii. TMVP MVPs;
         iv. HMVP MVPs;
         V. Non-adjacent MVPs;
         vi. Constructed MVPs (such as pairwise MVPs);
         vii. Inherited affine MV candidates;
         viii. Constructed affine MV candidates;
         ix. SbTMVP candidates.
   d) In one example, this process may be conducted multiple times on different set of candidates.
      1. For example, a set of candidates (such as non-adjacent MVP candidates) may be sorted, and the N non-adjacent MVP candidates with the lowest costs may be put into the candidate list. After the whole candidate list is constructed, the costs of candidates in the list may be calculated and the candidates may be reordered based on the costs.
13. It is proposed that the MVP list construction process may involve both reordering of a single group/category and a joint group which contains candidates from more than one category.
   a) In one example, the joint group may include candidates from a first and a second category.
      1. Alternatively, furthermore, the first and second category may be defined as the non-adjacent MVP category and HMVP category.
      2. Alternatively, furthermore, the first and second category may be defined as the non-adjacent MVP category and HMVP category, and the joint group may include candidates from a third category, e.g., TMVP category.
   b) In one example, the single group may include candidates from a fourth category.
      1. Alternatively, furthermore, the fourth category may be defined as the adjacent MVP category.
14. Multiple groups or categories can be respectively reordered to construct MVP list.
   a) In one example, only one single group (all the candidates belong to one category, e.g. adjacent MVP, non-adjacent MVP, HMVP, etc.) is built and reordered in MVP list construction process.
   b) In one example, only one joint group (contains partial or all the candidates from multiple categories) is built and reordered in MVP list construction process.
   c) In one example, more than one group (regardless of single or joint) are respectively built and reordered in MVP list construction process.
      1. In one example, two or more single groups are respectively built and reordered in MVP list construction process.
      2. In one example, two or more joint groups are respectively built and reordered in MVP list construction process.
      3. In one example, one or multiple single groups and one or multiple joint groups are respectively reordered in MVP list construction process.
         a) In one example, one single groups and one joint groups are respectively built and reordered to construct MVP list.
         b) In one example, one single groups and multiple joint groups are respectively built and reordered to construct MVP list.
         c) In one example, multiple single groups and one joint groups are respectively built and reordered to construct MVP list.
         d) In one example, multiple single groups and multiple joint groups are respectively built and reordered to construct MVP list.
   d) In one example, candidates that belong to the same category can be divided into different groups, and are respectively reordered in the corresponding groups.
   e) In one example, only partial candidates in specific category are put into the single or joint group, and rest candidates in this category are not reordered.
   f) In above examples, the category may be
      1. adjacent neighboring MVPs;
      2. adjacent neighboring MVPs at specific location(s);
      3. TMVP MVPs;
      4. HMVP MVPs;
      5. Non-adjacent MVPs;
      6. Constructed MVPs (such as pairwise MVPs);
      7. Inherited affine MV candidates;
      8. Constructed affine MV candidates;
      9. SbTMVP candidates.
15. The proposed sorting method can also be applied to AMVP mode.
   a) In one example, the MVP in AMVP mode can be extended with non-adjacent MVP, non-adjacent TMVP and HMVP.
   b) In one example, MVP list for AMVP mode comprises K candidates, which are selected from M categories, such as adjacent MVPs, non-adjacent MVPs, non-adjacent TMVPs and HMVPs wherein K and M are integers.
      1. In one example, K could be smaller than M, or equal to M or greater than M.
      2. In one example, one candidate is selected from each category.
      3. Alternatively, for a given category, no candidate is selected.
      4. Alternatively, for a given category, more than 1 candidate is selected.
      5. In one example, MVP list for AMVP mode comprises 4 candidates, which are selected from adjacent MVPs, non-adjacent MVPs, non-adjacent TMVPs and HMVPs.
      6. In one example, each category of MVP candidates is respectively sorted with template matching cost, and the one with minimum cost in the corresponding category is selected and included in the MVP list.
      7. Alternatively, adjacent MVP candidates and a joint group of non-adjacent MVP, non-adjacent TMVP together with HMVP candidates are respectively sorted with template matching cost. One adjacent candidate with the minimum template matching cost is selected from adjacent MVP candidates, and three other candidates are derived by traversing the candidates in the joint group in an ascending order of template matching cost.
      8. In one example, MVP list for AMVP mode comprises 2 candidates, one comes from adjacent MVP and the other comes from non-adjacent MVP, non-adjacent TMVP or HMVP. In particular, adjacent MVP candidates and a joint group of non-adjacent MVP, non-adjacent TMVP together with HMVP are respectively sorted with template matching cost, and the one with minimum cost in the corresponding category (or group) is included in the MVP list.
16. The proposed sorting methods may be applied to other coding methods, e.g., for constructing a block vector list of IBC coded blocks.
   a) In one example, it may be used for affine coded blocks.
   b) Alternatively, furthermore, how to define the template cost may be dependent on the coding methods.
17. The usage of this method may be controlled with different coding level syntax, including but not limit to one or multiple of PU, CU, CTU, slice, picture, sequence levels.
18. On how to insert sorted candidates to MVP list.
   a) In one example, which candidates within the joint or separate group are included into MVP list depends on the sorting results of template matching cost.
   b) In one example, whether put the candidates within the separate or joint group into MVP list depends on the sorting results of template matching cost.
   c) In one example, how many candidates within the separate or joint group are included into MVP list depends on the sorting results of template matching cost.
      1. In one example, only one candidate with the smallest template matching cost is included into MVP list.
      2. In one group, top-N candidates regarding the template matching cost in an ascending order are included into MVP list, where N is the maximum allowed candidate number can be inserted into MVP list in the corresponding single or joint group.
         a) In one example, N can be a predefined constant for each single or joint group.
         b) Alternatively, N can be adaptively derived based on the template matching cost within the single or joint group.
         c) Alternatively, N can be signaled in the bitstream.
         d) In one example, different candidate groups share a same N value.
         c) Alternatively, different single or joint groups may have different N value.

### Pruning for MVP Candidates

19. The pruning for MVP candidates aims to increase the diversity within the MVP list, which can be realized by using appropriate threshold TH.
   a) In one example, if the two candidates point to same reference frame, they may both be included to MVP list only if the absolute difference between the corresponding X and Y components are either or both larger (or no smaller) than TH.
20. The pruning threshold can be signaled in the bitstream.
   b) In one example, the pruning threshold can be signaled either in PU, CU, CTU or slice level.
21. The pruning threshold may depend on the characteristics of the current block.
   c) In one example, the threshold may be derived by analyzing the diversity among the candidates.
   d) In one example, the optimal threshold can be derived through RDO.
22. The pruning for MVP candidates may be firstly performed within a single or joint group before being sorted.
   a) Alternatively, furthermore, for two MVP candidates belonging to two different groups or one belonging to a joint group and the other doesn't, pruning among these two MVP candidates are not performed before sorting.
   b) Alternatively, furthermore, pruning among multiple groups may be applied after the sorting.
23. The pruning for MVP candidates may be firstly performed among multiple groups and the sorting may be further applied to one or multiple single/joint groups.
   a) Alternatively, a MVP list may be firstly constructed with pruning among available MVP candidates involved. Afterwards, sorting may be further applied to reorder one or multiple single/joint groups.
   b) Alternatively, furthermore, for two MVP candidates belonging to two different groups or one belonging to a joint group and the other doesn't, pruning among these two MVP candidates is performed before sorting.
      Interaction with Other Coding Tools
24. After an MVP list with above sorting methods applied, the Adaptive Reordering Merge Candidates (ARMC) process may be further applied.
   a) In one example, the template costs used in the sorting process during MVP list construction may be further utilized in the ARMC.
   b) In another example, different template costs may be used in the sorting process and ARMC process.
      1. In one example, the template may be different for the sorting and ARMC process.
25. Whether to and/how to enable the sorting process may be dependent on the coding tool.
   a) In one example, when a certain tool (e.g., MMVD or affine mode) is enabled for a block, the sorting is disabled.
   b) In one example, for two different tools, the sorting rules may be different (e.g., being applied to different groups or different template settings).

### 2.6. Simplifications for Template Matching Based Video Coding Methods

The template matching based video coding methods are optimized in two aspects. Firstly, reference template derivation process is revised that the interpolation process in the prediction block generation process is replaced by different ways. Secondly, several fast strategies are devised to speedup the tools related to template matching.
It should be noted that the proposed methods can be utilized in ARMC, EMCD and template matching MV refinement, and can also be easily extended to other potential utilizations that require template matching process, e.g., template matching based candidates reorder for merge with motion vector difference (MMVD), Affine motion compensation, Subblock-based temporal motion vector prediction (SbTMVP) and so on. In yet another example, the proposed methods could be applied to other coding tools that requires motion information refinement processes, e.g., bilateral matching-based coding tools.
The detailed embodiments below should be considered as examples to explain general concepts. These embodiments should not be interpreted in a narrow way. Furthermore, these embodiments can be combined in any manner. Combination between embodiments of the present disclosure and others are also applicable.
1. It is proposed to replace the interpolation filtering process involved in the motion compensation process of an inter prediction signal generation process by other ways in the reference template generation process.
   a) It is proposed to exclude interpolation filtering process to generate a reference template even the motion vector point to fractional positions.
      i. In one example, it is proposed to use an integer precision to generate a reference template.
      ii. In one example, if a motion vector points to a fractional position, it is rounded to be an integer MV firstly.
         1. In one example, the fractional position is rounded toward zero (that is, a negative motion vector predictor is rounded toward positive infinity and a positive motion vector predictor is rounded toward negative infinity).
         2. In one example, the round step may larger than 1.
   b) It is proposed to use a different interpolation filter to generate reference templates for motion vectors pointing to fractional positions.
      i. In one example, a simplified interpolation filter may be applied.
         1. In one example, the simplified interpolation filter can be 2-tap bilinear, alternatively, it can also be 4-tap, 6-tap or 8-tap filter that belongs to DCT, DST, Lanczos or any other interpolation types.
      ii. In one example, a more complex interpolation filter (e.g., with longer filter taps) may be applied.
   c) The above methods may be used to reorder the merge candidates for template matching merge mode.
      i. In one example, integer precision can be used in ARMC, EMCD, LIC and any other potential scenarios.
      ii. The above methods may be used to reorder the candidates for regular merge mode.
         1. In one example, integer precision can be used to reorder the candidates for regular merge mode.
   d) In one example, whether to use above methods (e.g., integer precision, different interpolation filters) or not and/or how to use above methods can be signaled in the bitstream or determined on-the-fly according to decoded information.
      i. In one example, which method to be applied may be dependent on the coding tool.
      ii. In one example, which method to be applied may be dependent on block dimension.
      iii. In one example, integer precision may be used for a given color component (e.g., luma only).
      iv. Alternatively, integer precision may be used all of the three components.
2. Whether to and/or how to perform EMCD may be based on the maximum allowed candidate number within candidate list and/or available candidate number before being added to a candidate list.
   a) In one example, assuming the number of available candidates (valid candidates that can be used to build candidate list) is NAVAL, and the maximum allowed candidate number is NMAX (that is, at most NMAX candidates can be included into the ultimate merge list), then EMCD is enabled only when NAVAL. NMAX larger than a constant or adaptively derived threshold T.
3. It is proposed to organize the available merge candidates into subgroups.
   a) In one example, the available candidates can be categorized into subgroups, each subgroup contains a fixed or adaptively derived number of candidates, and each subgroup selects a fix number of candidates into the list. In the decoder side, only the candidates within a chosen subgroup need to be reordered.
   b) In one example, the candidates can be categorized into subgroups according to the candidates' category, such as non-adjacent MVP, temporal MVP (TMVP) or HMVP, etc.
4. It is proposed that a piece of information calculated by a first coding tool utilizing at least one template cost may be reused by a second coding tool utilizing at least one template cost.
   a) It is proposed to build a unified storage shared by ARMC, EMCD and any other potential tools to store the information of each merge candidate.
   b) In one example, this storage can be a map, table or other data structure.
   c) In one example, the stored information can be template matching cost.
   d) In one example, EMCD first traverses all the MVs associated with the available candidates and store the corresponding information (including but not limited to template matching cost) in this storage. Then ARMC and/or other potential tools can simply access the needed information from this shared storage without performing repeating calculation.

### 3. Problems

1) Existing MVP candidate list construction methods normally use a uniform threshold in the candidate pruning process, which does not fully exploit the distinct importance of potential MVP candidates, leading to low-efficiency of the constructed MVP list.
2) In existing MVP candidate list construction methods, adjacent MVPs have the highest priority to be included in the ultimate list. However, an adjacent MVP may not always be better than other candidates, i.e., non-adjacent MVP, HMVP, etc. Accordingly, it is beneficial to decrease the priority of those adjacent candidates with low-quality.

### 4. Detail Description

In this disclosure, an optimized MVP list derivation method based on template matching cost ordering is proposed. Instead of constructing the MVP list based on a predefined traversing order, an optimized MVP selecting approach by taking advantage of the matching cost in the reconstructed template region, such that more appropriate candidates are included in the list is investigated.
It should be noted that the proposed strategy for MVP list construction can be utilized in normal merge and AMVP list construction process and can also be easily extended to other modules that require MVP derivation, e.g., merge with motion vector difference (MMVD), Affine motion compensation, Subblock-based temporal motion vector prediction (SbTMVP) and so on.
In the following discussion, category represents the belongingness of an MVP candidate, e.g., non-adjacent MVP candidates belong to one category, HMVP candidates belonging to another category. A group denotes an MVP candidate set which contains one or multiple MVP candidates. In one example, a single group denotes an MVP candidate set in which all the candidates belong to one category, e.g., adjacent MVP, non-adjacent MVP, HMVP, etc. In another example, a joint group denotes an MVP candidate set which contains candidates from multiple categories.
The detailed embodiments below should be considered as examples to explain general concepts. These embodiments should not be interpreted in a narrow way. Furthermore, these embodiments can be combined in any manner. Combination between this disclosure and others are also applicable.
1. Multiple thresholds to determine whether a candidate could be added to a candidate list may be utilized in the candidate pruning process.
   a) A threshold may be used to determine whether a potential candidate can be put into a candidate list.
      i. For example, if the absolute difference of at least one component of the MV of the potential candidate and that of a candidate existing in the candidate list is smaller than a threshold, the potential candidate is not put into the list.
      ii. For example, if the absolute difference of all components of the MV of the potential candidate and that of a candidate existing in the candidate list is smaller than a threshold, the potential candidate is not put into the list.
   b) In one example, the candidate is a MVP candidate, the candidate pruning process is the MVP candidate pruning process, and the candidate list is a motion candidates list.
      i. In one example, the motion candidate list is a merge candidate list.
      ii. In one example, the motion candidate list is a AMVP candidate list.
      iii. In one example, the motion candidate list is an extend merge or AMVP list, such as sub-block merge candidate list, affine merge candidate list, MMVD list, GPM list, template matching merge list, biliteral matching merge list etc.
   c) In one example, the pruning thresholds may be different for two groups, where the group can be either a single group (containing only one category of candidates) or a joint group (containing at least two categories of candidates).
   d) Alternatively, only one threshold is used for all potential MVP candidates regardless of category and/or groups.
   c) In one example, N (e.g., N=2) thresholds are used in the pruning process.
      i. Assume A is the MVP set which contains all available MVP candidates regardless of category, in one example, a first threshold is used for a first subset of candidates in set A, and a second threshold is used for a second subset of candidates (e.g., the rest candidates excluding those in the first subset) in set A.
      ii. In one example, a first threshold is used for a single group denoted by A, and a second threshold is used for another group (single or joint)/multiple other groups/rest of candidates which are not with the same category as those in A.
         1) In one example, a first threshold is used for the single group of adjacent candidates, and a second threshold is used for the rest candidates, including but not limited to non-adjacent MVP, HMVP, pairwise MVP and zero MVP.
      iii. The first threshold may be larger than or smaller than the second threshold.
   f) Alternatively, furthermore, the threshold for a MVP category or group may be dependent on the decoded information, e.g., block dimension/coding methods (e.g., CIIP/MMVD) and/or the variance of motion information within the category or group.
2. Multi-pass reordering can be performed to construct an MVP list.
   a) In one example, the multi-pass may involve different reordering criteria.
   b) In one example, multi-pass reordering can be performed to multiple single/joint groups, wherein at least two single/joint groups may have overlap MVP candidates or not.
   c) In one example, K-pass (e.g., K=2) reordering is used to construct an MVP list.
      i. In one example, in the first pass, a single/joint group A is firstly reordered based on a first cost (e.g., template matching cost) sorting, and the candidate with the largest cost (CL) in A is identified and then transferred to another single/joint group B (e.g., B may comprise the rest of candidates which are not with the same category as those in A). Subsequently, group B conduct the 2 to K pass reorder based on the first cost (or other cost metrics) sorting. Finally, the candidates in group A (except CL) and B (CL included) are included in the MVP list in accordance with the sorted order.
      ii. In one example, the group A in above case is a single group of adjacent candidates, and group B is a joint group of non-adjacent candidates and HMVP.
      iii. Alternatively, group A and B may be any other single or joint candidate group.
3. At least one virtual candidate (e.g., pairwise MVP and zero MVP) may be involved in the at least one group.
   a) In one example, all the virtual candidates are treated with one joint group.
      i. Alternatively, each category of virtual candidates is treated as a single group.
      ii. In one example, the pairwise MVP and/or zero MVP are included in a single/joint group.
      iii. Alternatively, furthermore, the group which contains the virtual candidates is reordered and then put into a candidate list.
   b) Alternatively, the virtual candidates (e.g., pairwise MVP and/or zero MVP) are not included in any single/joint group.
      i. Alternatively, furthermore, no reordering process is applied to virtual candidates.
         1) Alternatively, furthermore, they may be further appended to candidate list.
      ii. In one example, one or more single/joint groups are constructed, where partial or all of the groups are reordered. In this case, at least one position in MVP list is preserved for the virtual candidates (e.g., pairwise MVP and/or zero MVP), which are appended to MVP list as the last or any other entry.
      iii. In one example, furthermore, a single group of adjacent candidates is firstly included in the MVP list, then a joint group of non-adjacent and HMVP are reordered and subsequently appended to MVP list. In this case, at least one position is preserved for the virtual candidates (e.g., pairwise MVP and/or zero MVP), which are appended to MVP list as the last or any other entry.
      iv. In one example, furthermore, a joint group of adjacent candidates, non-adjacent and HMVP are reordered and subsequently appended to MVP list, and the virtual candidates (e.g., pairwise MVP and/or zero MVP) are appended to MVP list as the last or any other entry.
   c) Alternatively, the virtual candidates (e.g., pairwise MVP) of one category are included in a single/joint group and the virtual candidates of another category are not included.
   d) In one example, no virtual candidates (e.g., pairwise MVP and/or zero MVP) appear in the ultimate MVP list when reordering operation is performed for MVP list construction.
4. The number of candidates of a single/joint group may not be allowed to exceed a maximum candidate number.
   a) In one example, a single/joint group is constructed with limited amount of candidates constrained by maximum number Nᵢ, where i∈[0,1, . . . , K] is the index of the corresponding group. Nᵢ may be the same or they may be different for different i.
   b) Alternatively, a first single/joint group may be constructed with at most Nᵢ MVP candidates, while a second single/joint groups may not have such constraint.
   c) In one example, Nᵢ is a fix value shared by both encoder and decoder.
      i. Alternatively, Nᵢ is determined by encoder and signalled in the bitstream. And decoder decodes Nᵢ value and then construct the corresponding iₜₕ single/joint group with at most Nᵢ candidates.
      ii. Alternatively, Nᵢ is derived in both encoder and decoder with the same operations, such that there is no need to signal the Nᵢ value.
         1) In one example, encoder and decoder may derive the Nᵢ value based on the variance of all available motion information for iₜₕ group.
         2) Alternatively, encoder and decoder may derive the Nᵢ value based on the number of all available candidates for iₜₕ group.
         3) Alternatively, furthermore, encoder and decoder may derive the Nᵢ value based on any information that encoder/decoder can both access to when constructing the MVP list.
   d) In one example, all or partial of the single/joint groups may share a same maximum candidate number N.
5. The construction of a single/joint group may depend on the maximum number constraint Nᵢ.
   a) In one example, all available MVP candidates for iₜₕ group are included in the group in accordance with a certain order. Once the candidate number in the current group reaches Nᵢ, the construction for group i is terminated.
   b) In one example, in above case, the order for group construction may be derived based on the distance between to-be-coded CU and MVP candidates, where a closer MVP candidate is assigned with a higher priority.
   c) Alternatively, the order may be derived based on a cost (such as a template matching) cost, where a MVP with a less cost has a higher priority.

### 5. Embodiments

In one example, when encoder/decoder starts to build an MVP candidate list for merge mode, different methods are used for different merge modes. In particular, if the current mode is regular/CIIP/MMVD/GPM/TPM/subblock merge mode, adjacent candidates are firstly put into MVP candidate list with a smaller pruning threshold T₁. Then a joint group which contains one or more than one category of MVP candidates (e.g., non-adjacent and HMVP candidates, note that a joint group can also comprises different partial or combination of candidates) is built, and pruning operation with a larger threshold T₂ is conducted within the joint group. In particular, at most M (e.g., 20) candidates are included in the joint group, where closer MVP positions have higher priority to be included. If the candidate number in the joint group reaches M, the construction for the joint group is terminated. Subsequently, template matching cost associated with each candidate within the join group is calculated. After that, encoder/decoder will append MVP list by traversing the candidates in the joint group in an ascending order of template matching cost until all the candidates in the joint group are traversed, or MVP list reaches Nₘₐₓ₋₁, where Nₘₐₓ₋₁=Nₘₐₓ−1, and Nₘₐₓ is the maximum allowed candidate number in MVP list. If all the candidates within the joint group are traversed and MVP list still has vacant positions, remaining candidates which are not belong to the joint group will be included in the MVP list in a predefined order until the list reaches Nₘₐₓ₋₁. Finally, pairwise MVP and/or zero MVP are appended to MVP list.
If current merge mode is template matching merge mode, a joint group which contains different category of MVP candidates (e.g. adjacent, non-adjacent and HMVP candidates, note that a joint group can also comprises different partial or combination of candidates) is firstly built, then pruning process and template Matching cost derivation are conducted in the same way as regular/CIIP/MMVD/GPM/TPM/subblock merge mode, where a smaller threshold is used for adjacent candidates, and a larger threshold is used for other candidates. In particular, at most K (e.g., 20) candidates are included in the joint group, where closer MVP positions have higher priority to be included. If the candidate number in the joint group reaches K, the construction for the joint group is terminated. Then, encoder/decoder will construct MVP list by traversing the candidates in the joint group in an ascending order of template matching cost until all the candidates in the joint group are traversed, or MVP list reaches Nₘₐₓ₋₁. If all the candidates within the joint group are traversed and MVP list still has vacant positions, remaining candidates which are not belong to the joint group will be included in the MVP list in a predefined order until the list reaches Nₘₐₓ₋₁. Finally, pairwise MVP and/or zero MVP are appended to MVP list.
In another example, when encoder/decoder starts to build a MVP candidate list for merge mode, different methods are used for different merge modes. In particular, if the current mode is regular/CIIP/MMVD/GPM/TPM/subblock merge mode, a single group of adjacent MVP is constructed with a smaller pruning threshold T₁, and the template matching cost associated with each candidates within the single group is calculated. After that, all the candidates in the single group are put into the MVP list except the one (termed as C_{Largest}) with the largest template matching cost. Then a joint group which contains one or more than one category of MVP candidates (e.g. non-adjacent and HMVP candidates, note that a joint group can also comprises different partial or combination of candidates) is built, and pruning operation with a larger threshold T₂ is conducted within the joint group. In particular, C_{Largest} is firstly included in the joint group as the first entry. And at most M (e.g., 20) candidates are included in the joint group, where closer MVP positions have higher priority to be included. If the candidate number in the joint group reaches M, the construction for the joint group is terminated. Subsequently, template matching cost associated with each candidate within the join group is calculated. After that, encoder/decoder will append MVP list by traversing the candidates in the joint group in an ascending order of template matching cost until all the candidates in the joint group are traversed, or MVP list reaches Nₘₐₓ₋₁. If all the candidates within the joint group are traversed and MVP list still has vacant positions, remaining candidates which are not belong to the joint group will be included in the MVP list in a predefined order until the list reaches Nₘₐₓ₋₁. Finally, pairwise MVP and/or zero MVP are appended to MVP list.

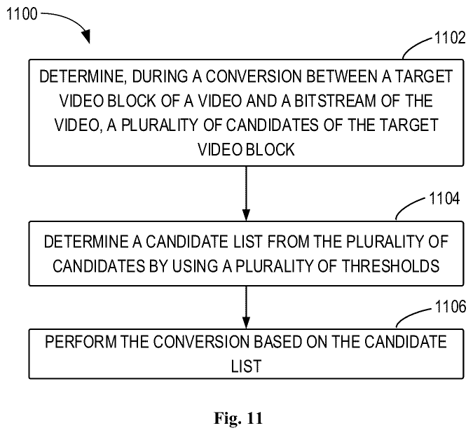

FIG. 11 illustrates a flowchart of a method 1100 for video processing in accordance with some embodiments of the present disclosure. The method 1100 may be implemented during a conversion between a target video block of a video and a bitstream of the video. As shown in FIG. 11, at block 1102, a plurality of candidates of the target video block is determined. At block 1104, a candidate list is determined from the plurality of candidates by using a plurality of thresholds. For example, the candidate list may be determined by using a candidate pruning process with the plurality of thresholds. The candidate pruning process may be the pruning process as described in Section 2.5.

In this way, a candidate list can be determined by more than one threshold. Instead of constructing the candidate list by using only one threshold, more appropriate candidate list can be determined. The coding effectiveness and coding efficiency can be thus improved.

At block 1106, the conversion is performed based on the candidate list. In some embodiments, the conversion may include encoding the target video block into the bitstream. Alternatively, or in addition, the conversion may include decoding the target video block from the bitstream.

In some embodiments, a first difference between a first candidate of the plurality of candidates and a second candidate in the candidate list is determined. If the first difference is greater than or equal to a first threshold of the plurality of thresholds, the first candidate may be added into the candidate list at block 1104.

In some embodiments, an absolute difference between at least one component of a first motion vector (MV) of the first candidate and at least one component of a second MV of the second candidate may be determined as the first difference. Alternatively, or in addition, in some embodiments, an absolute difference between all components of the first MV of the first candidate and all components of the second MV of the second candidate may be determined as the first difference.

In some embodiments, if the first difference is less than the first threshold, the first candidate may be absent from the candidate list. In other words, if the first difference is less than the first threshold, the first candidate may not be included in the candidate list.

In some embodiments, the plurality of candidates comprises a plurality of motion vector predictions (MVP) candidates, and the candidate list comprises a motion candidate list. For example, at block 1104, the motion candidate list may be constructed by performing an MVP candidate pruning process. The MVP candidate pruning process may be performed on the plurality of MVP candidates based on the plurality of thresholds.

In some embodiments, the motion candidate list may comprise one of the following: a merge candidate list, an advanced MVP (AMVP) candidate list, an extended merge candidate list, an extended AMVP candidate list, a sub-block merge candidate list, an affine merge candidate list, a merge mode with motion vector difference (MMVD) candidate list, a geometric partitioning mode (GPM) candidate list, a template matching merge candidate list, or a bilateral matching merge candidate list.

In some embodiments, a second threshold of the plurality of thresholds for a first group of candidates of the plurality candidates is different from a third threshold of the plurality of threshold for a second group of candidates of the plurality of candidates. group or a joint group. In some embodiments, the first group or second group comprises a single group comprising candidates of one candidate category. Alternatively, or in addition, in some embodiments, the first group or second group comprises a joint group comprising candidates of more than one candidate category. In other words, the pruning thresholds may be different for two groups, where the group may be either a single group or a joint group.

In some embodiments, one threshold is used for the plurality of candidates. For example, only one threshold may be used for all potential MVP candidates regardless of category and/or groups.

In some embodiments, the plurality of thresholds comprises two thresholds. In some embodiments, one of the two thresholds is greater than or less than the other one of the two thresholds.

In some embodiments, one threshold of the two thresholds may be used for a first subset of candidates of the plurality of candidates, and another threshold of the two thresholds may be used for a second subset of candidates of the plurality of candidates.

In some embodiments, the second subset of candidates comprises rest candidates of the plurality of candidates excluding the first subset of candidates.

In some embodiments, one threshold of the two thresholds may be used for a single group of candidates of the plurality of candidates. Candidates in the single group is of a first candidate category. Another threshold of the two thresholds may be used for at least one further candidate of the plurality of candidates. The at least one further candidate is of at least one further candidate category different from the first candidate category.

In some embodiments, the at least one further candidate comprises at least one of: a further single group of candidates being of a further candidate category different from the first candidate category, or a joint group of candidates being of at least two further candidate categories different from the first candidate category.

In some embodiments, the single group of candidates comprises a single group of adjacent candidates. The at least one further candidate may comprise at least one of the following: a non-adjacent motion vector prediction (MVP) candidate, a history-based MVP (HMVP) candidate, a pairwise MVP candidate, or a zero MVP candidate.

In some embodiments, the plurality of thresholds may be determined based on decoded information of the target video block. By way of example, the decoded information may comprise at least one of the following: a block dimension of the target video block, a coding tool of the target video block, a variance of motion information of a group of candidates of the target video block, a variance of motion information of candidates of the target video block being of a candidate category, or any other suitable decoded information.

In some embodiments, the coding tool may comprise at least one of: a combination of intra and inter predication (CIIP) merge mode coding tool, or a merge mode with motion vector difference (MMVD) coding tool.

According to embodiments of the present disclosure, a non-transitory computer-readable recording medium is proposed. A bitstream of a video is stored in the non-transitory computer-readable recording medium. The bitstream of the video is generated by a method performed by a video processing apparatus. According to the method, a plurality of candidates of a target video block of the video is determined. A candidate list is determined from the plurality of candidates by using a plurality of thresholds. The bitstream is generated based on the candidate list.

According to embodiments of the present disclosure, a method for storing a media presentation of a media is proposed. In the method, a plurality of candidates of a target video block of the video is determined. A candidate list is determined from the plurality of candidates by using a plurality of thresholds. The bitstream is generated based on the candidate list.

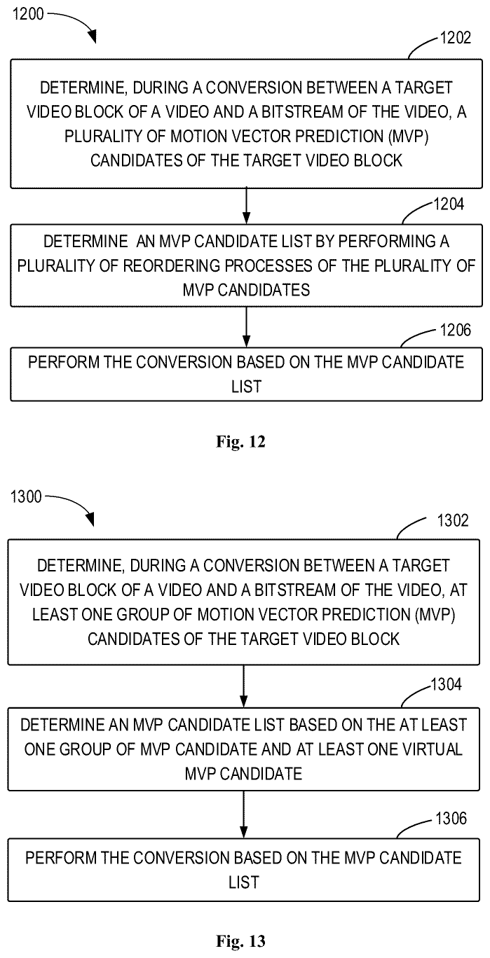

FIG. 12 illustrates a flowchart of a method 1200 for video processing in accordance with some embodiments of the present disclosure. The method 1200 may be implemented during a conversion between a target video block of a video and a bitstream of the video. As shown in FIG. 12, at block 1202, a plurality of motion vector prediction (MVP) candidates of the target video block is determined. At block 1204, an MVP candidate list is determined by performing a plurality of reordering processes of the plurality of MVP candidates. For example, the plurality of reordering processes may be a multi-pass reordering.

In this way, an MVP candidate list can be determined by performing the plurality of reordering processes. Instead of constructing the MVP candidate list by using only one reordering, more appropriate MVP candidate list can be determined. The coding effectiveness and coding efficiency can be thus improved.

At block 1206, the conversion is performed based on the MVP candidate list. In some embodiments, the conversion may include encoding the target video block into the bitstream. Alternatively, or in addition, the conversion may include decoding the target video block from the bitstream.

In some embodiments, at block 1204, a first reordering process may be performed on a first group of MVP candidates of the plurality of MVP candidates. A second reordering process may be performed on a second group of MVP candidates of the plurality of MVP candidates. For example, the first reordering process may be a first-pass reordering. The second reordering process may be a second-pass reordering.

In some embodiments, the first group or the second group of MVP candidates may comprise one of the following: a single group of MVP candidates comprising candidates of one candidate category, or a joint group of MVP candidates comprising candidates of at least two candidate categories.

In some embodiments, the first and second groups comprise an overlap MVP candidate. Alternatively, or in addition, in some embodiments, the first and second groups comprise no overlap MVP candidate. That is, at least two single/joint groups may have overlap MVP candidates or not.

In some embodiments, at block 1204, the MVP candidate list may be determined by performing a multi-pass reordering by using different reordering criteria. For example, the multi-pass reordering comprises a two-pass reordering.

In some embodiments, a first candidate with a largest cost may be obtained by performing a first-pass reordering on a first group of candidates of the plurality of candidates based on a first cost sorting. In some embodiments, the first cost sorting comprises a template matching cost-based sorting. The first candidate may be transferred from the first group to a second group of candidates of the plurality of candidates. A 2 to K pass reordering may be performed on the second group of candidates based on the first cost sorting or a second cost sorting, K being an integer greater than 1. The MVP candidate list may be determined based on the first-pass ordering and the 2 to K pass reordering.

In some embodiments, the first group or the second group may comprise one of: a single group of MVP candidates comprising candidates of one candidate category, or a joint group of MVP candidates comprising candidates of at least two candidate categories.

In some embodiments, the second group comprises rest candidates of the plurality of candidates excluding from the first group. Candidates in the second group is of a different candidate category from candidates in the first group.

In some embodiments, the first group comprises a single group of adjacent MVP candidates, and the second group comprises a joint group of non-adjacent MVP candidates and history-based MVP (HMVP) candidates.

According to embodiments of the present disclosure, a non-transitory computer-readable recording medium is proposed. A bitstream of a video is stored in the non-transitory computer-readable recording medium. The bitstream of the video is generated by a method performed by a video processing apparatus. According to the method, a plurality of motion vector prediction (MVP) candidates of the target video block of the video is determined. An MVP candidate list is determined by performing a plurality of reordering processes of the plurality of MVP candidates. The bitstream is generated based on the MVP candidate list.

According to embodiments of the present disclosure, a method for storing a media presentation of a media is proposed. In the method, a plurality of motion vector prediction (MVP) candidates of the target video block of the video is determined. An MVP candidate list is determined by performing a plurality of reordering processes of the plurality of MVP candidates. The bitstream is generated based on the MVP candidate list.

FIG. 13 illustrates a flowchart of a method 1300 for video processing in accordance with some embodiments of the present disclosure. The method 1300 may be implemented during a conversion between a target video block of a video and a bitstream of the video. As shown in FIG. 13, at block 1302, at least one group of motion vector prediction (MVP) candidates of the target video block of the video is determined. At block 1304, an MVP candidate list is determined based on the at least one group of MVP candidate and at least one virtual MVP candidate.

In this way, an MVP candidate list can be determined by taking the virtual MVP candidates into consideration. Instead of constructing the MVP candidate list without considering the virtual candidates, more appropriate MVP candidate list can be determined. The coding effectiveness and coding efficiency can be thus improved.

At block 1306, the conversion is performed based on the MVP candidate list. In some embodiments, the conversion may include encoding the target video block into the bitstream. Alternatively, or in addition, the conversion may include decoding the target video block from the bitstream.

In some embodiments, the at least one virtual MVP candidate may comprise at least one of: a pairwise MVP candidate, or a zero MVP candidate.

In some embodiments, the at least one virtual MVP candidate may be added into the at least one group. At block 1304, the MVP candidate list may be determined based on the at least one group. By way of example, at block 1304, the MVP candidate list may be determined by ordering the at least one group. For example, the group which contains the virtual candidates may be reordered and then put into a candidate list.

In some embodiments, the at least one virtual MVP candidate may be added into a joint group of the at least one group. The joint group comprises MVP candidates of more than one candidate category. For example, all the virtual candidates may be treated with one joint candidate group.

Alternatively, or in addition, in some embodiments, a first virtual MVP candidate of the at least one virtual candidate may be added into a single group of the at least one group. The first virtual MVP candidate and MVP candidates in the single group are of a first candidate category. For example, each category of virtual candidates may be treated as a single group.

In some embodiments, a pairwise MVP candidate or a zero MVP candidate may be added into a single group or a joint group. The single group comprises MVP candidates of one candidate category. The joint group comprises MVP candidates of more than one candidate category.

In some embodiments, at block 1304, a first portion of the MVP candidate list may be determined based on the at least one group. The at least one virtual MVP candidate may be added into the MVP candidate list as a remaining portion of the MVP candidate list.

In some embodiments, the at least one virtual MVP candidate may be added into the MVP candidate list without reordering the at least one virtual MVP candidate. That is, no reordering process is applied to virtual candidates.

In some embodiments, the at least one virtual MVP candidate may be appended to the MVP candidate list as a last entry or any other entry. For example, at least one position in the MVP candidate list may be preserved for the virtual candidates, which are appended to the MVP candidate list as the last or any other entry.

In some embodiments, a partial or all of the at least one group may be reordered. The at least one group may comprise at least one of a single group or a joint group. The single group comprises MVP candidates of one candidate category. The joint group comprises MVP candidates of more than one candidate category. The first portion of the MVP candidate list may be determined based on the reordering.

In some embodiments, a single group of adjacent MVP candidates may be added into the first portion. A joint group of non-adjacent MVP candidates and history-based MVP (HMVP) candidates may be reordered. At least one candidate from the joint group may be added into the first portion based on the reordering.

Alternatively, or in addition, in some embodiments, a joint group of adjacent MVP candidates, non-adjacent MVP candidates and history-based MVP (HMVP) candidates may be reordered. At least one candidate from the joint group may be added into the first portion based on the reordering.

In some embodiments, a first virtual MVP candidate of the at least one virtual MVP candidate may be added into a first group of the at least one group without adding a second virtual MVP candidate of the at least one virtual MVP candidate into the first group. The second virtual MVP candidate is of a second candidate category different from a first candidate category of the first virtual MVP candidate. At block 1304, the MVP candidate list may be determined based at least in part on the first group and the second virtual candidate. In other words, the virtual candidates (for example, the pairwise MVP) of one category may be included in a single/joint group and the virtual candidates of another category may not be included.

In some embodiments, the first group may comprise one of: a single group of MVP candidates comprising candidates of one candidate category, or a joint group of MVP candidates comprising candidates of at least two candidate categories.

In some embodiments, the at least one group of MVP candidate and at least one virtual MVP candidate may be reordered. At block 1304, the MVP candidate list may be determined based on the reordering.

In some embodiments, the at least one virtual MVP candidate may be absent from the MVP candidate list. That is, no virtual candidates may be appear in the ultimate MVP candidate list if a reordering operation is performed for the MVP candidate list construction.

According to embodiments of the present disclosure, a non-transitory computer-readable recording medium is proposed. A bitstream of a video is stored in the non-transitory computer-readable recording medium. The bitstream of the video is generated by a method performed by a video processing apparatus. According to the method, at least one group of motion vector prediction (MVP) candidates of the target video block of the video is determined. An MVP candidate list is determined based on the at least one group of MVP candidate and at least one virtual MVP candidate. The bitstream is generated based on the MVP candidate list.

According to embodiments of the present disclosure, a method for storing a media presentation of a media is proposed. In the method, at least one group of motion vector prediction (MVP) candidates of the target video block of the video is determined. An MVP candidate list is determined based on the at least one group of MVP candidate and at least one virtual MVP candidate. The bitstream is generated based on the MVP candidate list.

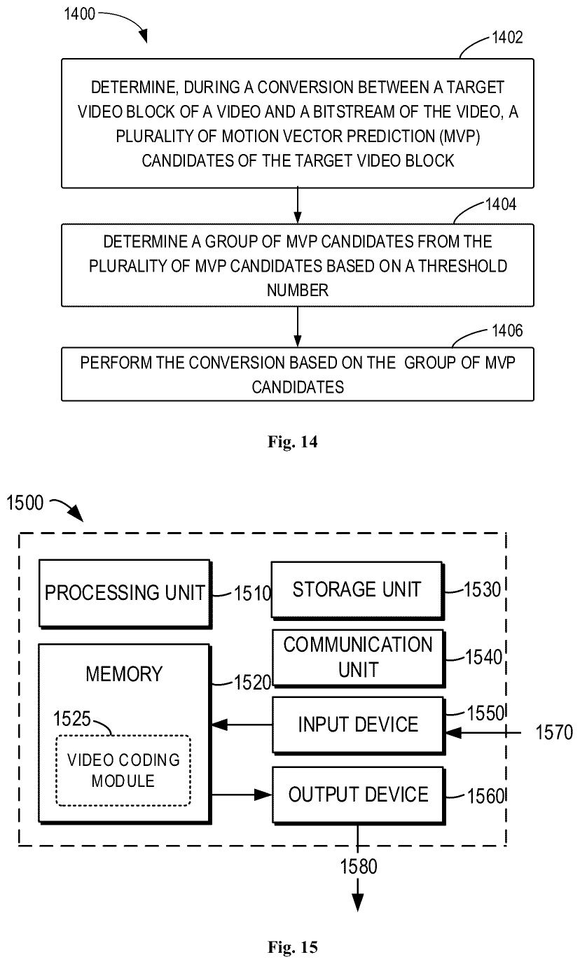

FIG. 14 illustrates a flowchart of a method 1400 for video processing in accordance with some embodiments of the present disclosure. The method 1400 may be implemented during a conversion between a target video block of a video and a bitstream of the video. As shown in FIG. 14, at block 1402, a plurality of motion vector prediction (MVP) candidates of the target video block of the video is determined. At block 1404, a group of MVP candidates from the plurality of MVP candidates may be determined based on a threshold number. As used herein, the threshold number may also be referred to as a maximum candidate number.

In this way, a group of MVP candidates can be determined by setting a threshold number for the group. Instead of constructing the group of MVP candidates without setting a threshold number, more appropriate MVP candidates can be determined. The coding effectiveness and coding efficiency can be thus improved.

At block 1406, the conversion is performed based on the group of MVP candidates. In some embodiments, the conversion may include encoding the target video block into the bitstream. Alternatively, or in addition, the conversion may include decoding the target video block from the bitstream.

In some embodiments, a number of MVP candidates in the group of MVP candidates is less than or equal to the threshold number. By way of example, the group may comprise one of: a single group of MVP candidates comprising candidates of one candidate category, or a joint group of MVP candidates comprising candidates of at least two candidate categories. That is, the number of candidates in a single or joint group may not be allowed to exceed the threshold number (e.g., the maximum candidate number).

In some embodiments, a first threshold number for a first group of MVP candidates may be different from a second threshold number for a second group of MVP candidates. Alternatively, or in addition, in some embodiments, a first threshold number for a first group of MVP candidates may be the same with a second threshold number for a second group of MVP candidates. That is, the maximum candidate number for different groups may be the same or different.

In some embodiments, a number of candidates in a further group of MVP candidates may be greater than the threshold number. For example, a first single/joint group may be constructed with at most N MVP candidates, while a second single/joint group may not have such constraint.

In some embodiments, the threshold number is shared by an encoder and a decoder associated with the conversion.

In some embodiments, the threshold number may be determined by the encoder. The threshold number may be included in the bitstream. That is, the threshold number may be signaled in the bitstream.

In some embodiments, the threshold number in the bitstream may be decoded. At block 1404, the group of MVP candidates may be determined by adding at most the threshold number of MVP candidates into the group.

In some embodiments, the threshold number may be derived by performing a same operation by the encoder and the decoder. In such cases, there is no need to include the threshold number in the bitstream. For example, the threshold number may be determined based on a variance of available motion information for the group. For another example, the threshold number may be determined based on a number of MVP candidates in the plurality of MVP candidates available for the group. For a further example, the threshold number may be determined based on information shared by the encoder and the decoder.

In some embodiments, the threshold number may be shared by at least a partial of more than one group of MVP candidates of the target video block.

In some embodiments, available MVP candidates available for the group may be determined from the plurality of MVP candidates. The available MVP candidates may be added into the group based on a candidate order until a number of MVP candidates in the group being equal to the threshold number. That is, once the candidate number in the current group reaches the threshold number, the construction for the group may be terminated.

In some embodiments, the candidate order may be determined based on distances between the target video block and the available MVP candidates. In some embodiments, a first available MVP candidate having a first distance with the target video block is ordered ahead of a second available MVP candidate having a second distance with the target video block farer than the first distance. That is, a closer MVP candidate may be assigned with a higher priority.

Alternatively, or in addition, in some embodiments, the candidate order may be determined based on costs of the available MVP candidates. For example, the costs of the available MVP candidates may comprise template matching costs of the available MVP candidates or other suitable costs of the available MVP candidates.

In some embodiments, a first available MVP candidate having a first cost is ordered ahead of a second available MVP candidate having a second cost greater than the first cost. That is, an MVP with a less cost may have a higher priority.

According to embodiments of the present disclosure, a non-transitory computer-readable recording medium is proposed. A bitstream of a video is stored in the non-transitory computer-readable recording medium. The bitstream of the video is generated by a method performed by a video processing apparatus. According to the method, a plurality of motion vector prediction (MVP) candidates of the target video block of the video is determined. A group of MVP candidates may be determined from the plurality of MVP candidates based on a threshold number. The bitstream is generated based on the group of MVP candidates.

According to embodiments of the present disclosure, a method for storing a media presentation of a media is proposed. In the method, a plurality of motion vector prediction (MVP) candidates of the target video block of the video is determined. A group of MVP candidates may be determined from the plurality of MVP candidates based on a threshold number. The bitstream is generated based on the group of MVP candidates.

It is to be understood that the above method 1100, method 1200, method 1300 and/or method 1400 may be used in combination or separately. Any suitable combination of these methods may be applied. Scope of the present disclosure is not limited in this regard.

By using these methods 1100, 1200, 1300 and 1400 separately or in combination, the MVP candidate list may be improved. In this way, the coding effectiveness and coding efficiency can be improved.

Implementations of the present disclosure can be described in view of the following clauses, the features of which can be combined in any reasonable manner.

Clause 1. A method for video processing, comprising: determining, during a conversion between a target video block of a video and a bitstream of the video, a plurality of candidates of the target video block; determining a candidate list from the plurality of candidates by using a plurality of thresholds; and performing the conversion based on the candidate list.

Clause 2. The method of clause 1, wherein determining the candidate list comprises: determining a first difference between a first candidate of the plurality of candidates and a second candidate in the candidate list; and if the first difference is greater than or equal to a first threshold of the plurality of thresholds, adding the first candidate into the candidate list.

Clause 3. The method of clause 2, wherein determining the first difference comprises one of the following: determining an absolute difference between at least one component of a first motion vector (MV) of the first candidate and at least one component of a second MV of the second candidate; or determining an absolute difference between all components of the first MV of the first candidate and all components of the second MV of the second candidate.

Clause 4. The method of clause 2 or clause 3, wherein the first candidate is absent from the candidate list if the first difference is less than the first threshold.

Clause 5. The method of any of clauses 1-4, wherein the plurality of candidates comprises a plurality of motion vector predictions (MVP) candidates, and the candidate list comprises a motion candidate list.

Clause 6. The method of clause 5, wherein determining the candidate list comprises: determining the motion candidate list by performing an MVP candidate pruning process on the plurality of MVP candidates based on the plurality of thresholds.

Clause 7. The method of clause 5 or clause 6, wherein the motion candidate list comprises one of the following: a merge candidate list, an advanced MVP (AMVP) candidate list, an extended merge candidate list, an extended AMVP candidate list, a sub-block merge candidate list, an affine merge candidate list, a merge mode with motion vector difference (MMVD) candidate list, a geometric partitioning mode (GPM) candidate list, a template matching merge candidate list, or a bilateral matching merge candidate list.

Clause 8. The method of any of clauses 1-7, wherein a second threshold of the plurality of thresholds for a first group of candidates of the plurality candidates is different from a third threshold of the plurality of threshold for a second group of candidates of the plurality of candidates.

Clause 9. The method of clause 8, wherein the first group or second group comprises a single group comprising candidates of one candidate category.

Clause 10. The method of clause 8, wherein the first group or second group comprises a joint group comprising candidates of more than one candidate category.

Clause 11. The method of any of clauses 1-10, wherein one threshold is used for the plurality of candidates.

Clause 12. The method of any of clauses 1-10, wherein the plurality of thresholds comprises two thresholds.

Clause 13. The method of clause 12, wherein one threshold of the two thresholds is used for a first subset of candidates of the plurality of candidates, and another threshold of the two thresholds is used for a second subset of candidates of the plurality of candidates.

Clause 14. The method of clause 13, wherein the second subset of candidates comprises rest candidates of the plurality of candidates excluding the first subset of candidates.

Clause 15. The method of clause 12, wherein one threshold of the two thresholds is used for a single group of candidates of the plurality of candidates, candidates in the single group being of a first candidate category, and another threshold of the two thresholds is used for at least one further candidate of the plurality of candidates, the at least one further candidate being of at least one further candidate category different from the first candidate category.

Clause 16. The method of clause 15, wherein the at least one further candidate comprises at least one of: a further single group of candidates being of a further candidate category different from the first candidate category, or a joint group of candidates being of at least two further candidate categories different from the first candidate category.

Clause 17. The method of clause 15 or clause 16, wherein the single group of candidates comprises a single group of adjacent candidates, and the at least one further candidate comprises at least one of the following: a non-adjacent motion vector prediction (MVP) candidate, a history-based MVP (HMVP) candidate, a pairwise MVP candidate, or a zero MVP candidate.

Clause 18. The method of any of clauses 12-17, wherein one of the two thresholds is greater than or less than the other one of the two thresholds.

Clause 19. The method of any of clauses 1-18, further comprising: determining the plurality of thresholds based on decoded information of the target video block.

Clause 20. The method of clause 19, wherein the decoded information comprises at least one of the following: a block dimension of the target video block, a coding tool of the target video block, a variance of motion information of a group of candidates of the target video block, or a variance of motion information of candidates of the target video block being of a candidate category.

Clause 21. The method of clause 20, wherein the coding tool comprises at least one of: a combination of intra and inter predication (CIIP) merge mode coding tool, or a merge mode with motion vector difference (MMVD) coding tool.

Clause 22. A method for video processing, comprising: determining, during a conversion between a target video block of a video and a bitstream of the video, a plurality of motion vector prediction (MVP) candidates of the target video block; determining an MVP candidate list by performing a plurality of reordering processes of the plurality of MVP candidates; and performing the conversion based on the MVP candidate list.

Clause 23. The method of clause 22, wherein performing the plurality of reordering processes comprises: performing a first reordering process on a first group of MVP candidates of the plurality of MVP candidates; and performing a second reordering process on a second group of MVP candidates of the plurality of MVP candidates.

Clause 24. The method of clause 23, wherein the first group or the second group of MVP candidates comprises one of the following: a single group of MVP candidates comprising candidates of one candidate category, or a joint group of MVP candidates comprising candidates of at least two candidate categories.

Clause 25. The method of clause 23 or clause 24, wherein: the first and second groups comprise an overlap MVP candidate, or the first and second groups comprise no overlap MVP candidate.

Clause 26. The method of any of clauses 22-25, wherein determining an MVP candidate list by performing the plurality of reordering processes comprises: determining the MVP candidate list by performing a multi-pass reordering by using different reordering criteria.

Clause 27. The method of any of clauses 22-26, wherein the multi-pass reordering comprises a two-pass reordering.

Clause 28. The method of clause 26, wherein determining the MVP candidate list by performing the multi-pass reordering comprises: obtaining a first candidate with a largest cost by performing a first-pass reordering on a first group of candidates of the plurality of candidates based on a first cost sorting; transferring the first candidate from the first group to a second group of candidates of the plurality of candidates; performing a 2 to K pass reordering on the second group of candidates based on the first cost sorting or a second cost sorting, K being an integer greater than 1; and determining the MVP candidate list based on the first-pass ordering and the 2 to K pass reordering.

Clause 29. The method of clause 28, wherein the first cost sorting comprises a template matching cost-based sorting.

Clause 30. The method of clause 28 or clause 29, wherein the first group or the second group comprises one of: a single group of MVP candidates comprising candidates of one candidate category, or a joint group of MVP candidates comprising candidates of at least two candidate categories.

Clause 31. The method of clause 30, wherein the second group comprises rest candidates of the plurality of candidates excluding from the first group, candidates in the second group being of a different candidate category from candidates in the first group.

Clause 32. The method of any of clauses 28-31, wherein the first group comprises a single group of adjacent MVP candidates, and the second group comprises a joint group of non-adjacent MVP candidates and history-based MVP (HMVP) candidates.

Clause 33. A method for video processing, comprising: determining, during a conversion between a target video block of a video and a bitstream of the video, at least one group of motion vector prediction (MVP) candidates of the target video block; determining an MVP candidate list based on the at least one group of MVP candidate and at least one virtual MVP candidate; and performing the conversion based on the MVP candidate list.

Clause 34. The method of clause 33, wherein the at least one virtual MVP candidate comprises at least one of: a pairwise MVP candidate, or a zero MVP candidate.

Clause 35. The method of clause 33 or clause 34, wherein determining the MVP candidate list based on the at least one group and the at least one virtual MVP candidate comprises: adding the at least one virtual MVP candidate into the at least one group; and determining the MVP candidate list based on the at least one group.

Clause 36. The method of clause 35, wherein determining the MVP candidate list based on the at least one group comprises: determining the MVP candidate list by ordering the at least one group.

Clause 37. The method of clause 35 or clause 36, wherein adding the at least one virtual MVP candidate into the at least one group comprises: adding the at least one virtual MVP candidate into a joint group of the at least one group, the joint group comprising MVP candidates of more than one candidate category.

Clause 38. The method of clause 35 or clause 36, wherein adding the at least one virtual MVP candidate into the at least one group comprises: adding a first virtual MVP candidate of the at least one virtual candidate into a single group of the at least one group, the first virtual MVP candidate and MVP candidates in the single group being of a first candidate category.

Clause 39. The method of any of clauses 35-38, wherein adding the at least one virtual MVP candidate into the at least one group comprises: adding a pairwise MVP candidate or a zero MVP candidate into a single group or a joint group, the single group comprising MVP candidates of one candidate category, the joint group comprising MVP candidates of more than one candidate category.

Clause 40. The method of clause 33 or clause 34, wherein determining the MVP candidate list based on the at least one group and the at least one virtual MVP candidate comprises: determining a first portion of the MVP candidate list based on the at least one group; and adding the at least one virtual MVP candidate into the MVP candidate list as a remaining portion of the MVP candidate list.

Clause 41. The method of clause 40, wherein adding the at least one virtual MVP candidate into the MVP candidate list comprises: adding the at least one virtual MVP candidate into the MVP candidate list without reordering the at least one virtual MVP candidate.

Clause 42. The method of clause 40 or clause 41, wherein adding the at least one virtual MVP candidate into the MVP candidate list comprises: appending the at least one virtual MVP candidate to the MVP candidate list as a last entry or another entry.

Clause 43. The method of any of clauses 40-42, wherein determining a first portion of the MVP candidate list based on the at least one group comprises: reordering a partial or all of the at least one group, the at least one group comprising at least one of a single group or a joint group, the single group comprising MVP candidates of one candidate category, the joint group comprising MVP candidates of more than one candidate category; and determining the first portion of the MVP candidate list based on the reordering.

Clause 44. The method of any of clauses 40-42, wherein determining a first portion of the MVP candidate list based on the at least one group comprises: adding a single group of adjacent MVP candidates into the first portion; reordering a joint group of non-adjacent MVP candidates and history-based MVP (HMVP) candidates; and adding at least one candidate from the joint group into the first portion based on the reordering.

Clause 45. The method of any of clauses 40-42, wherein determining a first portion of the MVP candidate list based on the at least one group comprises: reordering a joint group of adjacent MVP candidates, non-adjacent MVP candidates and history-based MVP (HMVP) candidates; and adding at least one candidate from the joint group into the first portion based on the reordering.

Clause 46. The method of clause 33 or clause 34, wherein determining the MVP candidate list based on the at least one group and the at least one virtual MVP candidate comprises: adding a first virtual MVP candidate of the at least one virtual MVP candidate into a first group of the at least one group without adding a second virtual MVP candidate of the at least one virtual MVP candidate into the first group, the second virtual MVP candidate being of a second candidate category different from a first candidate category of the first virtual MVP candidate; and determining the MVP candidate list based at least in part on the first group and the second virtual candidate.

Clause 47. The method of clause 46, wherein the first group comprises one of: a single group of MVP candidates comprising candidates of one candidate category, or a joint group of MVP candidates comprising candidates of at least two candidate categories.

Clause 48. The method of clause 33 or clause 34, wherein determining an MVP candidate list based on the at least one group of MVP candidate and at least one virtual MVP candidate comprises: reordering the at least one group of MVP candidate and at least one virtual MVP candidate; and determining the MVP candidate list based on the reordering.

Clause 49. The method of clause 48, wherein the at least one virtual MVP candidate is absent from the MVP candidate list.

Clause 50. A method for video processing, comprising: determining, during a conversion between a target video block of a video and a bitstream of the video, a plurality of motion vector prediction (MVP) candidates of the target video block; determining a group of MVP candidates from the plurality of MVP candidates based on a threshold number; and performing the conversion based on the group of MVP candidates.

Clause 51. The method of clause 50, wherein a number of MVP candidates in the group of MVP candidates is less than or equal to the threshold number.

Clause 52. The method of clause 50 or clause 51, wherein a first threshold number for a first group of MVP candidates is different from a second threshold number for a second group of MVP candidates.

Clause 53. The method of clause 50 or clause 51, wherein a first threshold number for a first group of MVP candidates is the same with a second threshold number for a second group of MVP candidates.

Clause 54. The method of any of clauses 50-53, wherein a number of candidates in a further group of MVP candidates is greater than the threshold number.

Clause 55. The method of any of clauses 50-54, wherein the threshold number is shared by an encoder and a decoder associated with the conversion.

Clause 56. The method of clause 55, further comprising: determining the threshold number by the encoder; and including the threshold number in the bitstream.

Clause 57. The method of clause 56, wherein determining the group of MVP candidates based on the threshold number comprises: decoding the threshold number in the bitstream; and determining the group of MVP candidates by adding at most the threshold number of MVP candidates into the group.

Clause 58. The method of clause 55, further comprising: deriving the threshold number by performing a same operation by the encoder and the decoder.

Clause 59. The method of clause 58, wherein deriving the threshold number comprises one of the following: determining the threshold number based on a variance of available motion information for the group; determining the threshold number based on a number of MVP candidates in the plurality of MVP candidates available for the group; or determining the threshold number based on information shared by the encoder and the decoder.

Clause 60. The method of any of clauses 50-59, wherein the threshold number is shared by at least a partial of more than one group of MVP candidates of the target video block.

Clause 61. The method of any of clauses 50-60, wherein the group comprises one of: a single group of MVP candidates comprising candidates of one candidate category, or a joint group of MVP candidates comprising candidates of at least two candidate categories.

Clause 62. The method of any of clauses 50-61, wherein determining the group of MVP candidates based on the threshold number comprises: determining available MVP candidates available for the group from the plurality of MVP candidates; and adding the available MVP candidates into the group based on a candidate order until a number of MVP candidates in the group being equal to the threshold number.

Clause 63. The method of clause 62, further comprising: determining the candidate order based on one of the following: distances between the target video block and the available MVP candidates, or costs of the available MVP candidates.

Clause 64. The method of clause 63, wherein the costs of the available MVP candidates comprise template matching costs of the available MVP candidates.

Clause 65. T method of clause 63 or clause 64, wherein a first available MVP candidate having a first cost is ordered ahead of a second available MVP candidate having a second cost greater than the first cost.

Clause 66. T method of clause 63, wherein a first available MVP candidate having a first distance with the target video block is ordered ahead of a second available MVP candidate having a second distance with the target video block farer than the first distance.

Clause 67. The method of any of clauses 1-66, wherein the conversion includes encoding the target video block into the bitstream.

Clause 68. The method of any of clauses 1-66, wherein the conversion includes decoding the target video block from the bitstream.

Clause 69. An apparatus for processing video data comprising a processor and a non-transitory memory with instructions thereon, wherein the instructions upon execution by the processor, cause the processor to perform a method in accordance with any of clauses 1-68.

Clause 70. A non-transitory computer-readable storage medium storing instructions that cause a processor to perform a method in accordance with any of clauses 1-68.

Clause 71. A non-transitory computer-readable recording medium storing a bitstream of a video which is generated by a method performed by a video processing apparatus, wherein the method comprises: determining a plurality of candidates of a target video block of the video; determining a candidate list from the plurality of candidates by using a plurality of thresholds; and generating the bitstream based on the candidate list.

Clause 72. A method for storing a bitstream of a video, comprising: determining a plurality of candidates of a target video block of the video; determining a candidate list from the plurality of candidates by using a plurality of thresholds; generating the bitstream based on the candidate list; and storing the bitstream in a non-transitory computer-readable recording medium.

Clause 73. A non-transitory computer-readable recording medium storing a bitstream of a video which is generated by a method performed by a video processing apparatus, wherein the method comprises: determining a plurality of motion vector prediction (MVP) candidates of the target video block of the video; determining an MVP candidate list by performing a plurality of reordering processes of the plurality of MVP candidates; and generating the bitstream based on the MVP candidate list.

Clause 74. A method for storing a bitstream of a video, comprising: determining a plurality of motion vector prediction (MVP) candidates of the target video block of the video; determining an MVP candidate list by performing a plurality of reordering processes of the plurality of MVP candidates; generating the bitstream based on the MVP candidate list; and storing the bitstream in a non-transitory computer-readable recording medium.

Clause 75. A non-transitory computer-readable recording medium storing a bitstream of a video which is generated by a method performed by a video processing apparatus, wherein the method comprises: determining at least one group of motion vector prediction (MVP) candidates of the target video block of the video; determining an MVP candidate list based on the at least one group of MVP candidate and at least one virtual MVP candidate; and generating the bitstream based on the MVP candidate list.

Clause 76. A method for storing a bitstream of a video, comprising: determining at least one group of motion vector prediction (MVP) candidates of the target video block of the video; determining an MVP candidate list based on the at least one group of MVP candidate and at least one virtual MVP candidate; generating the bitstream based on the MVP candidate list; and storing the bitstream in a non-transitory computer-readable recording medium.

Clause 77. A non-transitory computer-readable recording medium storing a bitstream of a video which is generated by a method performed by a video processing apparatus, wherein the method comprises: determining a plurality of motion vector prediction (MVP) candidates of the target video block of the video; determining a group of MVP candidates from the plurality of MVP candidates based on a threshold number; and generating the bitstream based on group of MVP candidates.

Clause 78. A method for storing a bitstream of a video, comprising: determining a plurality of motion vector prediction (MVP) candidates of the target video block of the video; determining a group of MVP candidates from the plurality of MVP candidates based on a threshold number; generating the bitstream based on group of MVP candidates; and storing the bitstream in a non-transitory computer-readable recording medium.

### Example Device

FIG. 15 illustrates a block diagram of a computing device 1500 in which various embodiments of the present disclosure can be implemented. The computing device 1500 may be implemented as or included in the source device 110 (or the video encoder 114 or 200) or the destination device 120 (or the video decoder 124 or 300).

It would be appreciated that the computing device 1500 shown in FIG. 15 is merely for purpose of illustration, without suggesting any limitation to the functions and scopes of the embodiments of the present disclosure in any manner.

As shown in FIG. 15, the computing device 1500 includes a general-purpose computing device 1500. The computing device 1500 may at least comprise one or more processors or processing units 1510, a memory 1520, a storage unit 1530, one or more communication units 1540, one or more input devices 1550, and one or more output devices 1560.

In some embodiments, the computing device 1500 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1500 can support any type of interface to a user (such as “wearable” circuitry and the like).

The processing unit 1510 may be a physical or virtual processor and can implement various processes based on programs stored in the memory 1520. In a multi-processor system, multiple processing units execute computer executable instructions in parallel so as to improve the parallel processing capability of the computing device 1500. The processing unit 1510 may also be referred to as a central processing unit (CPU), a microprocessor, a controller or a microcontroller.

The computing device 1500 typically includes various computer storage medium. Such medium can be any medium accessible by the computing device 1500, including, but not limited to, volatile and non-volatile medium, or detachable and non-detachable medium. The memory 1520 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1530 may be any detachable or non-detachable medium and may include a machine-readable medium such as a memory, flash memory drive, magnetic disk or another other media, which can be used for storing information and/or data and can be accessed in the computing device 1500.

The computing device 1500 may further include additional detachable/non-detachable, volatile/non-volatile memory medium. Although not shown in FIG. 15, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1540 communicates with a further computing device via the communication medium. In addition, the functions of the components in the computing device 1500 can be implemented by a single computing cluster or multiple computing machines that can communicate via communication connections. Therefore, the computing device 1500 can operate in a networked environment using a logical connection with one or more other servers, networked personal computers (PCs) or further general network nodes.

The input device 1550 may be one or more of a variety of input devices, such as a mouse, keyboard, tracking ball, voice-input device, and the like. The output device 1560 may be one or more of a variety of output devices, such as a display, loudspeaker, printer, and the like. By means of the communication unit 1540, the computing device 1500 can further communicate with one or more external devices (not shown) such as the storage devices and display device, with one or more devices enabling the user to interact with the computing device 1500, or any devices (such as a network card, a modem and the like) enabling the computing device 1500 to communicate with one or more other computing devices, if required. Such communication can be performed via input/output (I/O) interfaces (not shown).

In some embodiments, instead of being integrated in a single device, some or all components of the computing device 1500 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1500 may be used to implement video encoding/decoding in embodiments of the present disclosure. The memory 1520 may include one or more video coding modules 1525 having one or more program instructions. These modules are accessible and executable by the processing unit 1510 to perform the functionalities of the various embodiments described herein.

In the example embodiments of performing video encoding, the input device 1550 may receive video data as an input 1570 to be encoded. The video data may be processed, for example, by the video coding module 1525, to generate an encoded bitstream. The encoded bitstream may be provided via the output device 1560 as an output 1580.

In the example embodiments of performing video decoding, the input device 1550 may receive an encoded bitstream as the input 1570. The encoded bitstream may be processed, for example, by the video coding module 1525, to generate decoded video data. The decoded video data may be provided via the output device 1560 as the output 1580.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a target video block of a video and a bitstream of the video, a plurality of candidates of the target video block;
determining a candidate list from the plurality of candidates by using a plurality of thresholds; and
performing the conversion based on the candidate list.

2. The method of claim 1, wherein determining the candidate list comprises:
determining a first difference between a first candidate of the plurality of candidates and a second candidate in the candidate list; and
if the first difference is greater than or equal to a first threshold of the plurality of thresholds, adding the first candidate into the candidate list,
wherein determining the first difference comprises one of:
determining an absolute difference between at least one component of a first motion vector (MV) of the first candidate and at least one component of a second MV of the second candidate; or
determining an absolute difference between all components of the first MV of the first candidate and all components of the second MV of the second candidate, wherein the first candidate is absent from the candidate list if the first difference is less than the first threshold.

3. The method of claim 1, wherein the plurality of candidates comprises a plurality of motion vector predictions (MVP) candidates, and the candidate list comprises a motion candidate list, wherein determining the candidate list comprises:
determining the motion candidate list by performing an MVP candidate pruning process on the plurality of MVP candidates based on the plurality of thresholds, wherein the motion candidate list comprises one of:
a merge candidate list,
an advanced MVP (AMVP) candidate list,
an extended merge candidate list,
an extended AMVP candidate list,
a sub-block merge candidate list,
an affine merge candidate list,
a merge mode with motion vector difference (MMVD) candidate list,
a geometric partitioning mode (GPM) candidate list,
a template matching merge candidate list, or
a bilateral matching merge candidate list.

4. The method of claim 1, wherein a second threshold of the plurality of thresholds for a first group of candidates of the plurality candidates is different from a third threshold of the plurality of threshold for a second group of candidates of the plurality of candidates,
wherein the first group or second group comprises a single group comprising candidates of one candidate category, or a joint group comprising candidates of more than one candidate category.

5. The method of claim 1, wherein one threshold is used for the plurality of candidates.

6. The method of claim 1, wherein the plurality of thresholds comprises two thresholds.

7. The method of claim 6, wherein one threshold of the two thresholds is used for a first subset of candidates of the plurality of candidates, and another threshold of the two thresholds is used for a second subset of candidates of the plurality of candidates,
wherein the second subset of candidates comprises rest candidates of the plurality of candidates excluding the first subset of candidates.

8. The method of claim 6, wherein one threshold of the two thresholds is used for a single group of candidates of the plurality of candidates, candidates in the single group being of a first candidate category, and
wherein another threshold of the two thresholds is used for at least one further candidate of the plurality of candidates, the at least one further candidate being of at least one further candidate category different from the first candidate category, wherein the at least one further candidate comprises at least one of:
a further single group of candidates being of a further candidate category different from the first candidate category, or
a joint group of candidates being of at least two further candidate categories different from the first candidate category, wherein the single group of candidates comprises a single group of adjacent candidates, and
the at least one further candidate comprises at least one of:
a non-adjacent motion vector prediction (MVP) candidate,
a history-based MVP (HMVP) candidate, a pairwise MVP candidate, or
a zero MVP candidate.

9. The method of claim 6, wherein one of the two thresholds is greater than or less than the other one of the two thresholds.

10. The method of claim 1, further comprising:
determining the plurality of thresholds based on decoded information of the target video block, wherein the decoded information comprises at least one of:
a block dimension of the target video block,
a coding tool of the target video block,
a variance of motion information of a group of candidates of the target video block, or
a variance of motion information of candidates of the target video block being of a candidate category, wherein the coding tool comprises at least one of:
a combination of intra and inter predication (CIIP) merge mode coding tool, or
a merge mode with motion vector difference (MMVD) coding tool.

11. The method of claim 1, further comprising:
determining a plurality of motion vector prediction (MVP) candidates of the target video block; and
determining an MVP candidate list by performing a plurality of reordering processes of the plurality of MVP candidates, wherein the conversion is performed based on the MVP candidate list.

12. The method of claim 11, wherein performing the plurality of reordering processes comprises:
performing a first reordering process on a first group of MVP candidates of the plurality of MVP candidates; and
performing a second reordering process on a second group of MVP candidates of the plurality of MVP candidates, wherein the first group or the second group of MVP candidates comprises one of:
a single group of MVP candidates comprising candidates of one candidate category, or a joint group of MVP candidates comprising candidates of at least two candidate categories, wherein:
the first and second groups comprise an overlap MVP candidate, or
the first and second groups comprise no overlap MVP candidate, wherein determining an MVP candidate list by performing the plurality of reordering processes comprises:
determining the MVP candidate list by performing a multi-pass reordering by using different reordering criteria.

13. The method of claim 1, further comprising:
determining at least one group of motion vector prediction (MVP) candidates of the target video block; and
determining an MVP candidate list based on the at least one group of MVP candidate and at least one virtual MVP candidate, wherein the conversion is performed based on the MVP candidate list.

14. The method of claim 13, wherein the at least one virtual MVP candidate comprises at least one of: a pairwise MVP candidate, or a zero MVP candidate,
wherein determining the MVP candidate list based on the at least one group and the at least one virtual MVP candidate comprises:
adding the at least one virtual MVP candidate into the at least one group; and
determining the MVP candidate list based on the at least one group,
wherein determining the MVP candidate list based on the at least one group comprises: determining the MVP candidate list by ordering the at least one group,
wherein adding the at least one virtual MVP candidate into the at least one group comprises: adding a pairwise MVP candidate or a zero MVP candidate into a single group or a joint group, the single group comprising MVP candidates of one candidate category, the joint group comprising MVP candidates of more than one candidate category,
wherein determining the MVP candidate list based on the at least one group and the at least one virtual MVP candidate comprises: determining a first portion of the MVP candidate list based on the at least one group; and adding the at least one virtual MVP candidate into the MVP candidate list as a remaining portion of the MVP candidate list,
wherein adding the at least one virtual MVP candidate into the MVP candidate list comprises: adding the at least one virtual MVP candidate into the MVP candidate list without reordering the at least one virtual MVP candidate; and appending the at least one virtual MVP candidate to the MVP candidate list as a last entry or another entry,
wherein determining a first portion of the MVP candidate list based on the at least one group comprises: reordering a joint group of adjacent MVP candidates, non-adjacent MVP candidates and history-based MVP (HMVP) candidates; and adding at least one candidate from the joint group into the first portion based on the reordering.

15. The method of claim 1, further comprising:
determining a plurality of motion vector prediction (MVP) candidates of the target video block; and
determining a group of MVP candidates from the plurality of MVP candidates based on a threshold number, wherein the conversion is performed based on the group of MVP candidates.

16. The method of claim 15, wherein a number of MVP candidates in the group of MVP candidates is less than or equal to the threshold number, wherein a first threshold number for a first group of MVP candidates is different from a second threshold number for a second group of MVP candidates, or a first threshold number for a first group of MVP candidates is the same with a second threshold number for a second group of MVP candidates,
wherein a number of candidates in a further group of MVP candidates is greater than the threshold number, wherein the threshold number is shared by an encoder and a decoder associated with the conversion,
wherein the group comprises one of: a single group of MVP candidates comprising candidates of one candidate category, or a joint group of MVP candidates comprising candidates of at least two candidate categories,
wherein determining the group of MVP candidates based on the threshold number comprises:
determining available MVP candidates available for the group from the plurality of MVP candidates;
adding the available MVP candidates into the group based on a candidate order until a number of MVP candidates in the group being equal to the threshold number; and
determining the candidate order based on one of:
distances between the target video block and the available MVP candidates, or
costs of the available MVP candidates wherein the costs of the available MVP candidates comprise template matching costs of the available MVP candidates,
wherein a first available MVP candidate having a first cost is ordered ahead of a second available MVP candidate having a second cost greater than the first cost, or a first available MVP candidate having a first distance with the target video block is ordered ahead of a second available MVP candidate having a second distance with the target video block farer than the first distance.

17. The method of claim 1, wherein the conversion includes encoding the target video block into the bitstream, or decoding the target video block from the bitstream.

18. An apparatus for processing video data comprising a processor and a non-transitory memory with instructions thereon, wherein the instructions upon execution by the processor, cause the processor to:
determine, during a conversion between a target video block of a video and a bitstream of the video, a plurality of candidates of the target video block;
determine a candidate list from the plurality of candidates by using a plurality of thresholds; and
perform the conversion based on the candidate list.

19. A non-transitory computer-readable storage medium storing instructions that cause a processor to perform a method performed by a video processing apparatus, wherein the method comprises:
determining, during a conversion between a target video block of a video and a bitstream of the video, a plurality of candidates of the target video block;
determining a candidate list from the plurality of candidates by using a plurality of thresholds; and
performing the conversion based on the candidate list.

20. A non-transitory computer-readable recording medium storing a bitstream of a video which is generated by a method performed by a video processing apparatus, wherein the method comprises:
determining a plurality of candidates of a target video block of the video;
determining a candidate list from the plurality of candidates by using a plurality of thresholds; and
generating the bitstream based on the candidate list.
